(19) United States
(12) Patent Application Publication
(10) Pub. No.: US 2022/0400240 A1
(43) Pub. Date: Dec. 15, 2022

(54) IMAGING SYSTEM, CONTROL METHOD OF IMAGING SYSTEM, AND PROGRAM

(71) Applicant: FUJIFILM Corporation, Tokyo (JP)

(72) Inventors: Tetsuya FUJIKAWA, Saitama (JP); Masahiko SUGIMOTO, Saitama (JP); Shinichi SHIMOTSU, Saitama (JP); Toshihiro AOI, Saitama (JP)

(73) Assignee: FUJIFILM Corporation, Tokyo (JP)

(21) Appl. No.: 17/893,109

(22) Filed: Aug. 22, 2022

Related U.S. Application Data
(63) Continuation of application No. PCT/JP2020/040100, filed on Oct. 26, 2020.

(30) Foreign Application Priority Data
Feb. 28, 2020 (JP) 2020-034249

(51) Int. Cl. H04N 9/31; G02B 26/08

(52) U.S. Cl. CPC H04N 9/3194; H04N 9/3152; H04N 9/3155; G02B 26/0875

(57) ABSTRACT

An imaging system includes an imaging apparatus including a first optical system that transmits first wavelength range light, and a first image sensor that receives the first wavelength range light guided by the first optical system, and a projector including a first light source that emits the first wavelength range light, and a second optical system that emits the first wavelength range light emitted from the first light source to a subject side, in which an optical specification of the first optical system and an optical specification of the second optical system correspond to each other, the first optical system includes a first optical element that is displaced by receiving power generated by a first drive source, and the second optical system includes a second optical element that is displaced by receiving power generated by a second drive source.

### CROSS-REFERENCE TO RELATED APPLICATIONS

This application is a continuation application of International Application No. PCT/JP2020/040100 filed Oct. 26, 2020 the disclosure of which is incorporated herein by reference in its entirety. Further, this application claims priorities from Japanese Patent Application No. 2020-034249, filed Feb. 28, 2020, the disclosure of which is incorporated herein by reference in their entirety.

### TECHNICAL FIELD

The technology of the present disclosure relates to an imaging system, a control method of an imaging system, and a computer-readable storage medium storing a program.

### RELATED ART

JP2012-128128A discloses a camera module including an imaging element, an imaging optical system that connects an image which is an imaging target of the imaging element, an illumination optical system that irradiates the imaging target with light, and a light source unit that serves as a light source of the illumination optical system, in which the imaging optical system and the illumination optical system have an optical axis extending in the same direction, a principal point of the imaging optical system and a principal point of the illumination optical system are disposed at the same position in an optical axis direction, and a light-receiving part of the imaging element and a light-emitting part of the light source unit are disposed at different positions in the optical axis direction.

JP1995-218816A (JP-H07-218816A) discloses a focus adjustment device of an infrared ray imager including a flat plate window that transmits an infrared ray, an objective optical system that forms an image of the infrared ray transmitted through the flat plate window, a relay optical system that re-images the image formed by the objective optical system, and a two-dimensional image detector installed at an imaging point of the relay optical system, the focus adjustment device including an objective optical system optical axis direction moving mechanism that moves the objective optical system in an optical axis direction, a relay optical system adjustment two-dimensional detector that is provided with a relay optical system optical axis direction moving mechanism that moves the relay optical system in the optical axis direction, in which the flat plate window is further installed perpendicular to an optical axis and installed outside an image detection region of the two-dimensional image detector on the same plane as the two-dimensional image detector, a processing device that is provided with an objective optical system adjustment two-dimensional detector installed at a position symmetrical with respect to the optical axis of the relay optical system adjustment two-dimensional detector on the same plane as the two-dimensional image detector, that is provided with a light source at an optically conjugate position through the relay optical system adjustment two-dimensional detector and the relay optical system, that obtains an optical axis direction moving amount of the relay optical system such that a peak value of an output of the relay optical system adjustment two-dimensional detector is maximized, to output the obtained optical axis direction moving amount, and that obtains an optical axis direction moving amount of the objective optical system such that a peak value of an output of the objective optical system adjustment two-dimensional detector is maximized, to output the obtained optical axis direction moving amount, a relay optical system optical axis direction moving mechanism control device that controls the relay optical system optical axis direction moving mechanism to have a given optical axis direction moving amount, and an objective optical system optical axis direction moving mechanism control device that controls the objective optical system optical axis direction moving mechanism to have a given optical axis direction moving amount.

### SUMMARY

One embodiment according to the technology of the present disclosure provides an imaging system, a control method of an imaging system, and a computer-readable storage medium storing a program capable of matching an irradiation range of a projector with an imaging range of an imaging apparatus.

A first aspect according to the technology of the present disclosure relates to an imaging system including an imaging apparatus including a first optical system that transmits first wavelength range light, and a first image sensor that receives the first wavelength range light guided by the first optical system, and a projector including a first light source that emits the first wavelength range light, and a second optical system that emits the first wavelength range light emitted from the first light source to a subject side, in which an optical specification of the first optical system and an optical specification of the second optical system correspond to each other, the first optical system includes a first optical element that is displaced by receiving power generated by a first drive source, and the second optical system includes a second optical element that is displaced by receiving power generated by a second drive source.

A second aspect according to the technology of the present disclosure relates to the imaging system according to the first aspect, further including a processor that controls the imaging apparatus and the projector, in which the processor controls the first drive source and the second drive source.

A third aspect according to the technology of the present disclosure relates to the imaging system according to the second aspect, in which the processor controls the first drive source by outputting a control signal to the first drive source, and controls the second drive source by outputting the control signal to the second drive source as a signal for controlling the second drive source.

A fourth aspect according to the technology of the present disclosure relates to the imaging system according to the third aspect, in which the first optical element includes a first lens, the imaging system further includes a first adjustment mechanism capable of adjusting a position of the first lens by receiving the power generated by the first drive source, the second optical element includes a second lens, the imaging system further includes a second adjustment mechanism capable of adjusting a position of the second lens by receiving the power generated by the second drive source, and the second adjustment mechanism matches the position of the second lens to a position corresponding to the first lens of which a position is adjusted by the first adjustment mechanism, based on the control signal.

A fifth aspect according to the technology of the present disclosure relates to the imaging system according to the fourth aspect, in which the first lens is a first zoom lens, the second lens is a second zoom lens, and the second adjustment mechanism matches a position of the second zoom lens to a position corresponding to the first zoom lens of which a position is adjusted by the first adjustment mechanism, based on the control signal.

A sixth aspect according to the technology of the present disclosure relates to the imaging system according to the fourth or fifth aspect, in which the first lens is a first focus lens, the second lens is a second focus lens, and the second adjustment mechanism matches a position of the second focus lens to a position corresponding to the first focus lens of which a position is adjusted by the first adjustment mechanism, based on the control signal.

A seventh aspect according to the technology of the present disclosure relates to the imaging system according to any one of the second to sixth aspects, in which the processor adjusts an irradiation range of the projector.

An eighth aspect according to the technology of the present disclosure relates to the imaging system according to the seventh aspect, in which the processor adjusts the irradiation range of the projector based on image data obtained by imaging a subject by the imaging apparatus.

A ninth aspect according to the technology of the present disclosure relates to the imaging system according to the seventh or eighth aspect, in which the processor adjusts the irradiation range of the projector based on information on disposition of the imaging apparatus and the projector, and information on a distance to a subject.

A tenth aspect according to the technology of the present disclosure relates to the imaging system according to the ninth aspect, in which the imaging apparatus further includes a distance-measuring sensor that measures the distance.

An eleventh aspect according to the technology of the present disclosure relates to the imaging system according to the ninth aspect, in which the processor acquires the information on the distance to the subject based on an emission timing at which the first wavelength range light is emitted from the first light source, and a light-receiving timing at which first subject light obtained by reflecting the first wavelength range light emitted from the first light source by the subject is received by the first image sensor.

A twelfth aspect according to the technology of the present disclosure relates to the imaging system according to any one of the second to eleventh aspects, in which the second optical system further includes a third lens as the second optical element, and a drive mechanism capable of moving the third lens in a direction intersecting an optical axis of the second optical system, and the processor adjusts an irradiation range of the projector by controlling the drive mechanism to move the third lens.

A thirteenth aspect according to the technology of the present disclosure relates to the imaging system according to any one of the second to twelfth aspects, in which the processor adjusts an irradiation range of the projector by operating a first revolution mechanism capable of revolving the projector.

A fourteenth aspect according to the technology of the present disclosure relates to the imaging system according to any one of the second to thirteenth aspects, in which the second optical element includes a third zoom lens, and the processor adjusts an irradiation range of the projector by moving the third zoom lens along an optical axis of the second optical system.

A fifteenth aspect according to the technology of the present disclosure relates to the imaging system according to any one of the second to fourteenth aspects, in which the processor adjusts an irradiation range of the projector based on information on disposition of the imaging apparatus and the projector, information on a distance to a subject, and information on a focal length.

A sixteenth aspect according to the technology of the present disclosure relates to the imaging system according to any one of the second to fifteenth aspects, in which the first optical element includes a fourth zoom lens, the second optical element includes a fifth zoom lens, and the processor adjusts positions of the fourth zoom lens and the fifth zoom lens to a position at which a focal length of the second optical system is shorter than a focal length of the first optical system, based on information on disposition of the imaging apparatus and the projector, information on a distance to a subject, and information on a focal length.

A seventeenth aspect according to the technology of the present disclosure relates to the imaging system according to any one of the second to sixteenth aspects, in which, in a case in which an environment in which a subject is imaged satisfies a first predetermined condition, the processor stores information on a distance to the subject in accordance with an imaging condition of the imaging apparatus in a memory.

An eighteenth aspect according to the technology of the present disclosure relates to the imaging system according to the seventeenth aspect, in which the imaging condition includes information on a focal length of the imaging apparatus.

A nineteenth aspect according to the technology of the present disclosure relates to the imaging system according to the seventeenth or eighteenth aspect, in which the first predetermined condition includes a condition that an index indicating brightness in an imaging range including the subject is equal to or more than a first threshold value.

A twentieth aspect according to the technology of the present disclosure relates to the imaging system according to any one of the seventeenth to nineteenth aspects, in which the processor acquires the information on the distance to the subject in accordance with the imaging condition of the imaging apparatus stored in the memory, and adjusts an irradiation range of the projector based on the acquired information on the distance to the subject.

A twenty-first aspect according to the technology of the present disclosure relates to the imaging system according to any one of the seventeenth to twentieth aspects, in which the processor, in a case in which the environment in which the subject is imaged does not satisfy the first predetermined condition, acquires the information on the distance to the subject in accordance with the imaging condition of the imaging apparatus stored in the memory, and adjusts an irradiation range based on the acquired information on the distance to the subject.

A twenty-second aspect according to the technology of the present disclosure relates to the imaging system according to the twenty-first aspect, in which the processor, in a case in which the environment in which the subject is imaged does not satisfy the first predetermined condition and the environment in which the subject is imaged satisfies a second predetermined condition, acquires the information on the distance to the subject in accordance with the imaging condition of the imaging apparatus stored in the memory, and adjusts an irradiation range of the projector based on the acquired information on the distance to the subject.

A twenty-third aspect according to the technology of the present disclosure relates to the imaging system according to the twenty-second aspect, in which the second predetermined condition includes a condition that an index indicating brightness in an imaging range including the subject is equal to or less than a second threshold value.

A twenty-fourth aspect according to the technology of the present disclosure relates to the imaging system according to any one of the first to twenty-third aspects, in which the first wavelength range light is long-wavelength light having a longer wavelength than visible light.

A twenty-fifth aspect according to the technology of the present disclosure relates to the imaging system according to any one of the first to twenty-fourth aspects, in which the first optical system transmits the first wavelength range light and second wavelength range light, the first optical system further includes a separation optical system that separates light including the first wavelength range light and the second wavelength range light into the first wavelength range light and the second wavelength range light, the imaging apparatus further includes a second image sensor that receives the second wavelength range light separated by the separation optical system, the projector further includes a second light source that emits the second wavelength range light, the second optical system is capable of emitting the first wavelength range light and the second wavelength range light to the subject side, and the second optical system further includes a synthetic optical system that synthesizes the second wavelength range light emitted from the second light source with the first wavelength range light emitted from the first light source.

A twenty-sixth aspect according to the technology of the present disclosure relates to the imaging system according to the twenty-fifth aspect, in which the second wavelength range light is visible light, and the first wavelength range light is long-wavelength light having a longer wavelength than the visible light.

A twenty-seventh aspect according to the technology of the present disclosure relates to the imaging system according to the twenty-sixth aspect, in which the long-wavelength light is light in an infrared light wavelength range having a wavelength range of 1400 nm or more and 2600 nm or less.

A twenty-eighth aspect according to the technology of the present disclosure relates to the imaging system according to the twenty-seventh aspect, in which the infrared light wavelength range is a near-infrared light wavelength range including 1550 nm.

A twenty-ninth aspect according to the technology of the present disclosure relates to the imaging system according to the twenty-sixth aspect, in which the long-wavelength light is light in a near-infrared light wavelength range having a wavelength range of 750 nm or more and 1000 nm or less.

A thirtieth aspect according to the technology of the present disclosure relates to the imaging system according to any one of the first to twenty-ninth aspects, further including a second revolution mechanism capable of revolving the projector.

A thirty-first aspect according to the technology of the present disclosure relates to a control method of an imaging system including an imaging apparatus including a first optical system that transmits first wavelength range light, and a first image sensor that receives the first wavelength range light guided by the first optical system, and a projector including a first light source that emits the first wavelength range light, and a second optical system that emits the first wavelength range light emitted from the first light source to a subject side, in which an optical specification of the first optical system and an optical specification of the second optical system correspond to each other, the first optical system includes a first optical element that is displaced by receiving power generated by a first drive source, the second optical system includes a second optical element that is displaced by receiving power generated by a second drive source, and the imaging system further includes a processor that controls the imaging apparatus and the projector, the method including controlling the first drive source and the second drive source by the processor.

A thirty-second aspect according to the technology of the present disclosure relates to a program causing a computer applied to an imaging system including an imaging apparatus including a first optical system that transmits first wavelength range light, and a first image sensor that receives the first wavelength range light guided by the first optical system, and a projector including a first light source that emits the first wavelength range light, and a second optical system that emits the first wavelength range light emitted from the first light source to a subject side, in which an optical specification of the first optical system and an optical specification of the second optical system correspond to each other, the first optical system includes a first optical element that is displaced by receiving power generated by a first drive source, the second optical system includes a second optical element that is displaced by receiving power generated by a second drive source, and the imaging system further includes a processor that controls the imaging apparatus and the projector, to execute a process including controlling the first drive source and the second drive source.

### BRIEF DESCRIPTION OF THE DRAWINGS

FIG. 1 is a schematic configuration diagram showing an example of a configuration of an imaging system according to a first embodiment.

FIG. 2 is a block diagram showing an example of a configuration of an optical system and an electric system of an imaging apparatus according to the first embodiment.

FIG. 3A is a block diagram showing an example of the configuration of the optical system and the electric system of the imaging apparatus according to the first embodiment.

FIG. 3B is a block diagram showing an example of the configuration of the optical system and the electric system of the imaging apparatus according to the first embodiment.

FIG. 3C is a block diagram showing an example of the configuration of the optical system and the electric system of the imaging apparatus according to the first embodiment.

FIG. 4 is a block diagram showing an example of a configuration of an optical system and an electric system of a projector according to the first embodiment.

FIG. 5A is a block diagram showing an example of the configuration of the optical system and the electric system of the projector according to the first embodiment.

FIG. 5B is a block diagram showing an example of the configuration of the optical system and the electric system of the projector according to the first embodiment.

FIG. 5C is a block diagram showing an example of the configuration of the optical system and the electric system of the projector according to the first embodiment.

FIG. 5D is a block diagram showing an example of the configuration of the optical system and the electric system of the projector according to the first embodiment.

FIG. 6 is a block diagram showing an example of a configuration of an electric system of the imaging system according to the first embodiment.

FIG. 7 is a conceptual diagram provided for describing matching between an irradiation range and an imaging range by the imaging system according to the first embodiment.

FIG. 8 is a functional block diagram showing an example of a function of a CPU provided in a management device according to the first embodiment.

FIG. 9 is a conceptual diagram provided for describing adjusting the irradiation range by revolution in the imaging system according to the first embodiment.

FIG. 10 is a conceptual diagram provided for describing of adjusting the irradiation range by a lens shift mechanism in the imaging system according to the first embodiment.

FIG. 11 is a conceptual diagram provided for describing of adjusting the irradiation range by moving a zoom lens in the imaging system according to the first embodiment.

FIG. 12A is a flowchart showing an example of a flow of irradiation range adjustment processing according to the first embodiment.

FIG. 12B is a flowchart showing an example of the flow of the irradiation range adjustment processing according to the first embodiment.

FIG. 13 is a conceptual diagram provided for describing matching between the irradiation range and the imaging range by the imaging system according to a modification example of the first embodiment.

FIG. 14 is a functional block diagram showing an example of a function of a CPU provided in a management device according to a second embodiment.

FIG. 15 is a conceptual diagram provided for describing adjusting an irradiation range by revolution in an imaging system according to the second embodiment.

FIG. 16 is a flowchart showing an example of a flow of irradiation range adjustment processing according to the second embodiment.

FIG. 17 is a functional block diagram showing an example of a function of a CPU provided in a management device according to a third embodiment.

FIG. 18 is a conceptual diagram provided for describing of adjusting an irradiation range by moving a zoom lens in an imaging system according to the third embodiment.

FIG. 19 is a flowchart showing an example of a flow of irradiation range adjustment processing according to the third embodiment.

FIG. 20 is a functional block diagram showing an example of a function of a CPU provided in a management device according to a fourth embodiment.

FIG. 21 is a functional block diagram showing an example of a function of a CPU provided in a management device according to a fifth embodiment.

FIG. 22 is a functional block diagram showing an example of the function of the CPU provided in the management device according to the fifth embodiment.

FIG. 23A is a flowchart showing an example of a flow of irradiation range adjustment processing according to the fifth embodiment.

FIG. 23B is a flowchart showing an example of the flow of the irradiation range adjustment processing according to the fifth embodiment.

FIG. 23C is a flowchart showing an example of the flow of the irradiation range adjustment processing according to the fifth embodiment.

FIG. 24 is a conceptual diagram showing an example of an aspect in which a display control processing program and an irradiation range adjustment processing program according to the embodiment are installed in a computer in the management device from a storage medium in which the display control processing program and the irradiation range adjustment processing program are stored.

### DETAILED DESCRIPTION

An example of embodiments according to the technology of the present disclosure will be described with reference to the accompanying drawings.

First, the terms used in the following description will be described.

CPU refers to an abbreviation of “central processing unit”. RAM refers to an abbreviation of “random access memory”. ROM refers to an abbreviation of “read only memory”. ASIC refers to an abbreviation of “application specific integrated circuit”. PLD refers to an abbreviation of “programmable logic device”. FPGA refers to an abbreviation of “field-programmable gate array”. SoC refers to an abbreviation of “system-on-a-chip”. CMOS refers to an abbreviation of “complementary metal oxide semiconductor”. CCD refers to an abbreviation of charge-coupled device. SWIR refers to an abbreviation of “short-wavelength infrared”. TOF refers to an abbreviation of “time of flight”. LED refers to an abbreviation of “light emitting diode”.

SSD refers to an abbreviation of “solid state drive”. USB refers to an abbreviation of “universal serial bus”. HDD refers to an abbreviation of “hard disk drive”. EEPROM refers to an abbreviation of “electrically erasable and programmable read only memory”. EL refers to an abbreviation of “electro-luminescence”. A/D refers to an abbreviation of “analog to digital”. I/F refers to an abbreviation of “interface”. UI refers to an abbreviation of “user interface”. WAN refers to an abbreviation of “wide area network”. CRT refers to an abbreviation of “cathode ray tube”.

### First Embodiment

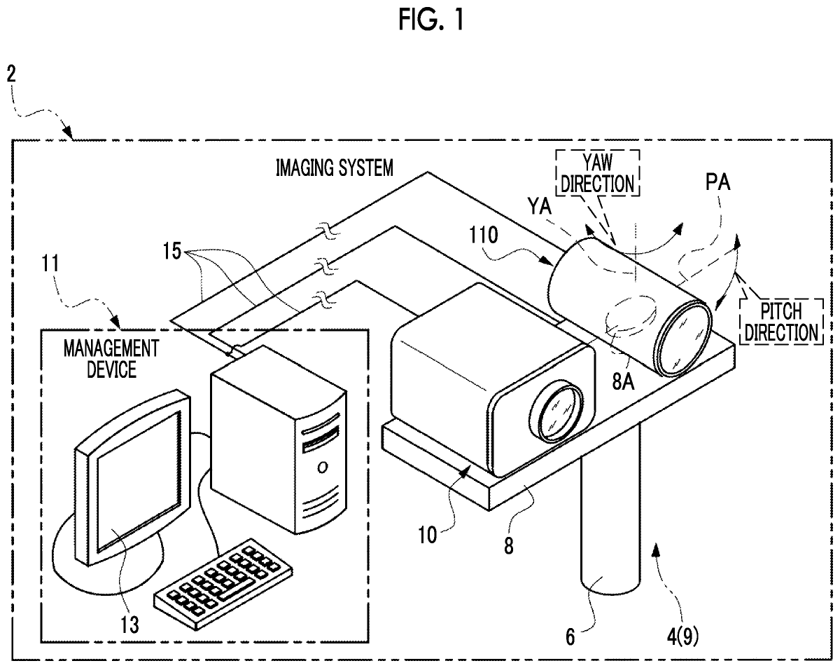

As an example, as shown in FIG. 1, an imaging system 2 includes an imaging apparatus 10, a projector 110, an attachment member 4, and a management device 11. The imaging system 2 is an example of an “imaging system” according to the technology of the present disclosure, the imaging apparatus 10 is an example of an “imaging apparatus” according to the technology of the present disclosure, and the projector 110 is an example of a “projector” according to the technology of the present disclosure. As will be described in detail below, the attachment member 4 also serves as a revolution mechanism 9.

The imaging apparatus 10 is installed on an indoor/outdoor road surface, a pillar, a wall, a floor, a part of a building (for example, a rooftop), or the like through the attachment member 4, images a monitoring target (hereinafter, also referred to as an “imaging region”) which is a subject, and generates a motion picture by imaging. The motion picture includes a multi-frame image obtained by imaging. The imaging apparatus 10 transmits the motion picture obtained by imaging to the management device 11 through a communication line 15.

The management device 11 includes a display 13. Here, as an example of the display 13, an organic EL display is adopted. It should be noted that the organic EL display is merely an example, and other types of display, such as a liquid crystal display, a plasma display, or a CRT display, may be adopted.

In the management device 11, the motion picture transmitted by the imaging apparatus 10 is received, and the received motion picture is displayed on the display 13.

In the present embodiment, the attachment member 4 includes a support column 6 and a support table 8 attached to an upper part of the support column 6. The imaging apparatus 10 and the projector 110 are attached to the support table 8.

The support table 8 can be revolved with respect to the support column 6, and by this revolution, the imaging apparatus 10 and the projector 110 can also be revolved together with the support table 8. Specifically, the revolution mechanism 9 is a two-axis revolution mechanism that can be rotated in a revolution direction with a pitch axis PA as a central axis (hereinafter, referred to as a “pitch direction”) and can be rotated in a revolution direction with a yaw axis YA as a central axis (hereinafter, referred to as a “yaw direction”). As described above, in the present embodiment, the attachment member 4 also serves as the revolution mechanism 9. Although the example is shown in which the two-axis revolution mechanism is the revolution mechanism 9, the technology of the present disclosure is not limited to this, and a three-axis revolution mechanism may be used. It should be noted that the revolution mechanism 9 is an example of a “first revolution mechanism” and a “second revolution mechanism” according to the technology of the present disclosure.

In addition, the support table 8 further includes a revolution table 8A for revolving the projector 110. The revolution table 8A is a table that supports the projector 110 from below, and can selectively revolve the projector 110 in the pitch direction and the yaw direction with respect to the imaging apparatus 10.

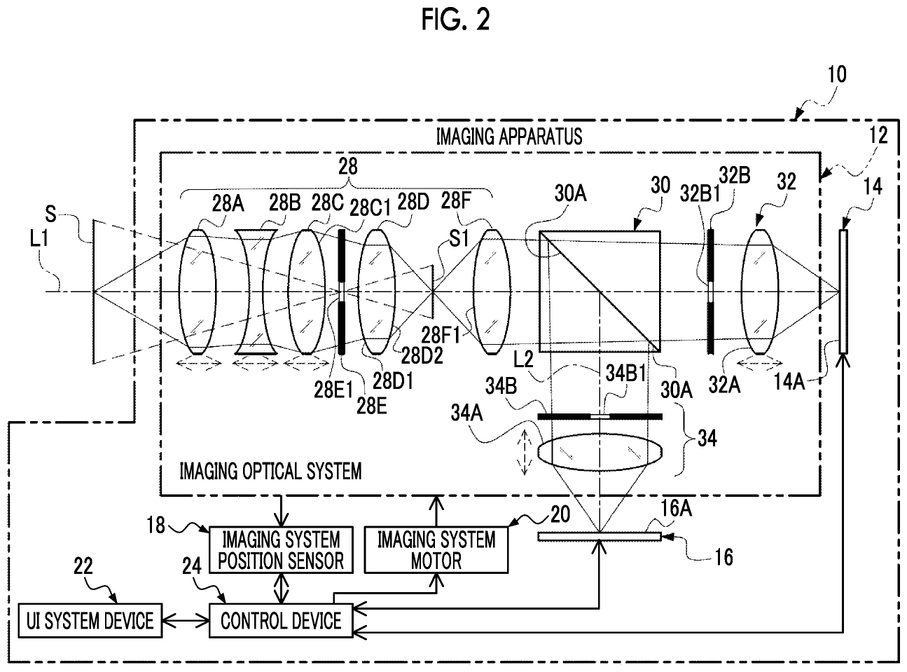

As an example, as shown in FIG. 2, the imaging apparatus 10 includes an imaging optical system 12, a first image sensor 14, a second image sensor 16, an imaging system position sensor 18, an imaging system motor 20, a UI system device 22, and a control device 24. The first image sensor 14 and the second image sensor 16 are positioned on a subsequent stage of the imaging optical system 12. The first image sensor 14 and the second image sensor 16 include a light-receiving surface 14A and a light-receiving surface 16A, respectively. Subject light indicating a subject S (hereinafter, also simply referred to as “subject light”) is imaged on the light-receiving surfaces 14A and 16A by the imaging optical system 12, and the imaging region is imaged by the first image sensor 14 and the second image sensor 16. It should be noted that the imaging optical system 12 is an example of a “first optical system” according to the technology of the present disclosure.

The imaging optical system 12 includes a first optical system 28, an imaging system prism 30, a second optical system 32, and a third optical system 34.

The subject light includes visible light, which is light in a visible wavelength range, and long-wavelength light having a longer wavelength than the visible light (hereinafter, also simply referred to as “long-wavelength light”) as light in different wavelength ranges. In the first image sensor 14, the subject light is separated by the imaging optical system 12, and the long-wavelength light imaged on the light-receiving surface 14A is imaged. In the second image sensor 16, the subject light is separated by the imaging optical system 12, and the visible light imaged on the light-receiving surface 16A is imaged. It should be noted that the long-wavelength light is an example of “first wavelength range light” according to the technology of the present disclosure, and the visible light is an example of “second wavelength range light” according to the technology of the present disclosure. In addition, in the following, for convenience of description, the long-wavelength light will be described as infrared light.

The imaging optical system 12 is provided with an imaging system infrared light optical path and an imaging system visible light optical path. In the imaging system infrared light optical path, the first optical system 28, the imaging system prism 30, and the second optical system 32 are disposed in order from the subject S side (object side) along an optical axis L1. The first optical system 28 transmits the infrared light and the visible light included in the subject light. The imaging system prism 30 separates the subject light into the infrared light and the visible light, and guides the infrared light and the visible light to the second optical system 32 and the third optical system 34, respectively. The first image sensor 14 is disposed on a subsequent stage of the second optical system 32. That is, the first image sensor 14 is positioned on an image side with respect to the second optical system 32, and receives the infrared light emitted from the second optical system 32.

The first image sensor 14 is an infrared light two-dimensional image sensor and images the infrared light. The first image sensor 14 includes the light-receiving surface 14A. The light-receiving surface 14A is formed by a plurality of photosensitive pixels (not shown) disposed in a matrix, each photosensitive pixel is exposed, and the photoelectric conversion is performed for each photosensitive pixel. In the first image sensor 14, a plurality of photoelectric conversion elements having sensitivity to the infrared light are adopted as the plurality of photosensitive pixels. In the first image sensor 14, the photoelectric conversion element includes an InGaAs photodiode in which an infrared light transmission filter is disposed and a CMOS read-out circuit. Here, although the InGaAs photodiode has been described, the technology of the present disclosure is not limited to this, and a simulation of type-II quantum well (T2SL) photodiode may be applied instead of the InGaAs photodiode. It should be noted that the first image sensor 14 is an example of a “first image sensor” according to the technology of the present disclosure.

The imaging system visible light optical path includes the optical axis L1 and an optical axis L2. The optical axis L2 is an optical axis perpendicular to the optical axis L1. In the imaging system visible light optical path, the first optical system 28 and the imaging system prism 30 are disposed in order from the subject S side along the optical axis L1. The optical axis L1 is branched into the optical axis L2 by the imaging system prism 30. In the imaging system visible light optical path, the third optical system 34 is disposed on the image side with respect to the imaging system prism 30 along the optical axis L2. The second image sensor 16 is disposed on a subsequent stage of the third optical system 34, that is, on the image side with respect to the third optical system 34. Stated another way, the third optical system 34 is provided between the imaging system prism 30 and the second image sensor 16. The second image sensor 16 receives the visible light emitted from the third optical system 34.

The second image sensor 16 is a visible light two-dimensional image sensor and images the visible light. The second image sensor 16 includes the light-receiving surface 16A. The light-receiving surface 16A is formed by a plurality of photosensitive pixels (not shown) disposed in a matrix, each photosensitive pixel is exposed, and the photoelectric conversion is performed for each photosensitive pixel. In the second image sensor 16, a plurality of photoelectric conversion elements having sensitivity to the visible light are adopted as the plurality of photosensitive pixels. In the second image sensor 16, the photoelectric conversion element includes a Si photodiode in which a color filter is disposed and a CMOS read-out circuit. The color filter is a filter corresponding to red (R), a filter corresponding to green (G), and a filter corresponding to blue (B), which are disposed on the light-receiving surface 16A in a specific arrangement pattern. Here, an X-Trans (registered trademark) arrangement is adopted as the specific arrangement pattern. The arrangement pattern is not limited to this, and may be other types of arrangement pattern, such as a bayer arrangement or a honeycomb arrangement. It should be noted that the second image sensor 16 is an example of a “second image sensor” according to the technology of the present disclosure.

The first optical system 28 includes a first lens group 28A, a second lens group 28B, a third lens group 28C, and a fourth lens group 28D in order from the subject S side. The first lens group 28A is a lens group having positive optical power, the second lens group 28B is a lens group having negative optical power, the third lens group 28C is a lens group having positive optical power, and the fourth lens group 28D is a lens group having positive optical power. The first optical system 28 includes the first lens group 28A as a focus lens. The second lens group 28B and the third lens group 28C are provided as a zoom lens. It should be noted that the second lens group 28B and the third lens group 28C are examples of a “first zoom lens” and a “fourth zoom lens” according to the technology of the present disclosure. It should be noted that the zoom lens in the present embodiment refers to a lens group that can be moved in a case of adjusting a focal length.

The first optical system 28 consists of the first lens group 28A, the second lens group 28B, the third lens group 28C, the fourth lens group 28D, a stop 28E, and a fifth lens group 28F. Each of the first lens group 28A, the second lens group 28B, the third lens group 28C, the fourth lens group 28D, and the fifth lens group 28F consists of a plurality of lenses. It should be noted that the first lens group 28A, the second lens group 28B, the third lens group 28C, the fourth lens group 28D, the stop 28E, and the fifth lens group 28F are examples of a “first optical element” according to the technology of the present disclosure.

In the first optical system 28, the first lens group 28A, the second lens group 28B, the third lens group 28C, the fourth lens group 28D, and the fifth lens group 28F are disposed in order from the subject S side along the optical axis L1. The third lens group 28C includes an emission surface 28C1, and the fourth lens group 28D includes an incident surface 28D1 and an emission surface 28D2. The emission surface 28C1 is a surface of the third lens group 28C positioned closest to the image side, the incident surface 28D1 is a surface of the fourth lens group 28D positioned closest to the subject S side, and the emission surface 28D2 is a surface of the fourth lens group 28D positioned closest to the image side. The stop 28E is disposed between the emission surface 28C1 and the incident surface 28D1. In the example shown in FIG. 2, the stop 28E is disposed at a position adjacent to the fourth lens group 28D (for example, between the emission surface 28C1 and the incident surface 28D1) on the subject S side with respect to the fourth lens group 28D in a direction of the optical axis L1. It should be noted that this is merely an example, and the stop 28E may be disposed in the fourth lens group 28D.

Both the first lens group 28A and the fourth lens group 28D are stationary lens groups. The stationary lens group is a lens group fixed to an image plane during changing magnification. Both the second lens group 28B and the third lens group 28C are movable lens groups. The movable lens group is a lens group in which an interval from an adjacent lens group is changed by moving along the direction of the optical axis L1 during changing magnification. Each of the first lens group 28A, the third lens group 28C, the fourth lens group 28D, and the fifth lens group 28F is a lens group that has positive power, and the second lens group 28B is a lens group that has negative power. It should be noted that, here, the lens groups, such as the first lens group 28A, the second lens group 28B, the third lens group 28C, the fourth lens group 28D, and the fifth lens group 28F have been described, but the technology of the present disclosure is not limited to this. For example, at least one of the first lens group 28A, the second lens group 28B, the third lens group 28C, the fourth lens group 28D, or the fifth lens group 28F may be one lens.

In the imaging apparatus 10, adjustment of a focus position is realized by the first optical system 28. The adjustment of the focus position is realized by, for example, a front lens element focus method. In the front lens element focus method, the first lens group 28A is moved along the direction of the optical axis L1, so that the infrared light is imaged on the light-receiving surface 14A at the focus position in accordance with the distance to the subject S. The “focus position” used herein refers to a position of the first lens group 28A on the optical axis L1 in a focused state. In addition, the first lens group 28A is an example of a “first focus lens” according to the technology of the present disclosure.

It should be noted that, in the first embodiment, the front lens element focus method is adopted, but the technology of the present disclosure is not limited to this, and a whole group feeding method, an inner focus method, or a rear focus method may be adopted. The “focus position” in a case of the whole group feeding method, the inner focus method, or the rear focus method refers to a position in a focused state among the positions on the optical axis L1 of the lens or the lens group that is moved along the direction of the optical axis L1 to adjust the focus position.

The stop 28E includes an aperture 28E1, and the subject light passes through the aperture 28E1. The aperture 28E1 is disposed at a position at which peripheral rays of the subject light pass through the optical axis L1. The stop 28E is a movable stop in which a diameter of the aperture 28E1 can be changed. That is, a light amount of the subject light indicating the subject S can be changed by the stop 28E.

The first optical system 28 forms an intermediate image S1 on the optical axis L1. Specifically, the intermediate image Si is formed between the stop 28E and the imaging system prism 30 by the first optical system 28. More specifically, the intermediate image S1 is formed by the first optical system 28 between the emission surface 28D2, which is the surface of the fourth lens group 28D closest to the image side, and an incident surface 28F1, which is the surface of the fifth lens group 28F closest to the subject S side. The fifth lens group 28F is disposed between the intermediate image S1 and the imaging system prism 30 on the optical axis L1. Since the fifth lens group 28F has positive power, the luminous flux of the subject light is incident on the imaging system prism 30 by giving a converging action to the subject light incident on the fifth lens group 28F as divergent light. That is, the fifth lens group 28F accommodates the peripheral rays of the incident subject light in the imaging system prism 30 by positive optical power.

In addition, the first optical system 28 emits the incident subject light to the imaging system prism 30. The imaging system prism 30 is an example of a “separation optical system” according to the technology of the present disclosure. The imaging system prism 30 separates the subject light transmitted through the first optical system 28 into near-infrared light and the visible light by a selective reflecting surface 30A. The imaging system prism 30 transmits the infrared light and reflects the visible light. That is, the imaging system prism 30 guides the infrared light to the second optical system 32 along the optical axis L1 and guides the visible light to the third optical system 34 along the optical axis L2.

It should be noted that, here, although the imaging system prism 30 has been described, the technology of the present disclosure is not limited to this, and the subject light may be separated into the infrared light and the visible light by a dichroic mirror and/or a half mirror instead of the imaging system prism 30. It should be noted that, in a case in which the half mirror is used, the light having an unneeded wavelength range may be removed, by a filter, from the infrared light and the visible light obtained by separating the subject light.

The infrared light separated from the subject light by the imaging system prism 30 is transmitted through the second optical system 32. The second optical system 32 is disposed on the image side with respect to the imaging system prism 30 along the direction of the optical axis L1. Stated another way, the second optical system 32 is disposed on a side on which the infrared light is emitted from the imaging system prism 30. The second optical system 32 includes a relay lens 32A and a stop 32B. The relay lens 32A is a lens that has positive power. The infrared light emitted from the imaging system prism 30 is incident on the relay lens 32A, and the relay lens 32A images the incident infrared light on the light-receiving surface 14A.

The stop 32B includes an aperture 32B1, and the subject light passes through the aperture 32B1. The aperture 32B1 is disposed at a position at which peripheral rays of the subject light pass through the optical axis L1. The stop 32B is a movable stop in which a diameter of the aperture 32B1 can be changed. That is, a light amount of the subject light indicating the subject S can be changed by the stop 32B.

The infrared light obtained by separating the subject light by the imaging system prism 30 is, as an example, long-wavelength light having a longer wavelength than the visible light in the subject light, and, light having an infrared light wavelength range of 1400 nanometers (nm) or more and 2600 nm or less is adopted here. In addition, the visible light is light having a short wavelength of 700 nm or less. The infrared light in the subject light is transmitted through the imaging system prism 30 with transmittance of about 90 percent (%), and the visible light in the subject light is reflected by the selective reflecting surface 30A with reflectivity exceeding about 90%.

The imaging system position sensor 18 and the imaging system motor 20 are connected to the imaging optical system 12. The imaging system position sensor 18 is a device that detects a position of the lens group, the relay lens, or the like constituting the imaging optical system 12, a diameter of the aperture of the stop, or the like. The imaging system motor 20 is a device that applies power to the lens group, the relay lens, or the stop that constitutes the imaging optical system 12.

The UI system device 22 is a device that receives an instruction from a user of the imaging system 2 (hereinafter, simply referred to as a “user”) or presents various pieces of information to the user. Examples of the device that receives the instruction from the user include a touch panel and a hard key. Examples of the device that presents various pieces of information to the user include a display and a speaker. The first image sensor 14, the second image sensor 16, the imaging system position sensor 18, the imaging system motor 20, and the UI system device 22 are connected to the control device 24. The first image sensor 14, the second image sensor 16, the imaging system position sensor 18, the imaging system motor 20, and the UI system device 22 are controlled by the control device 24.

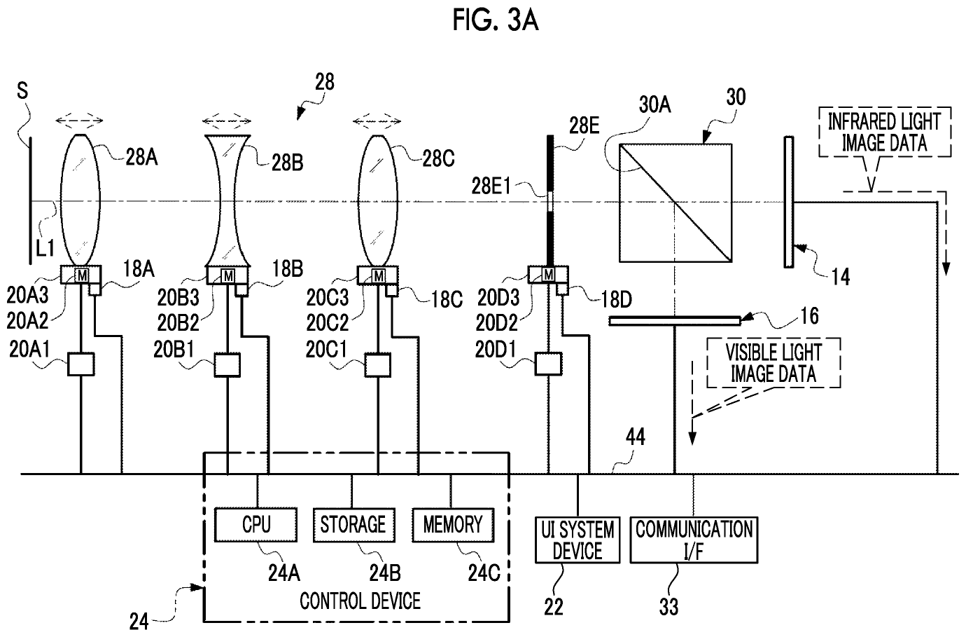

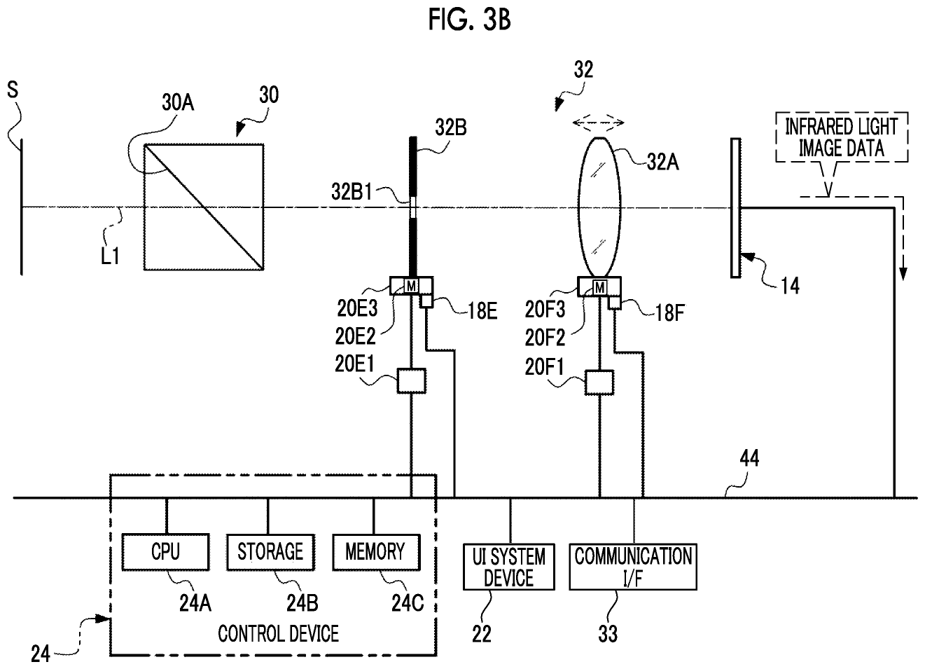

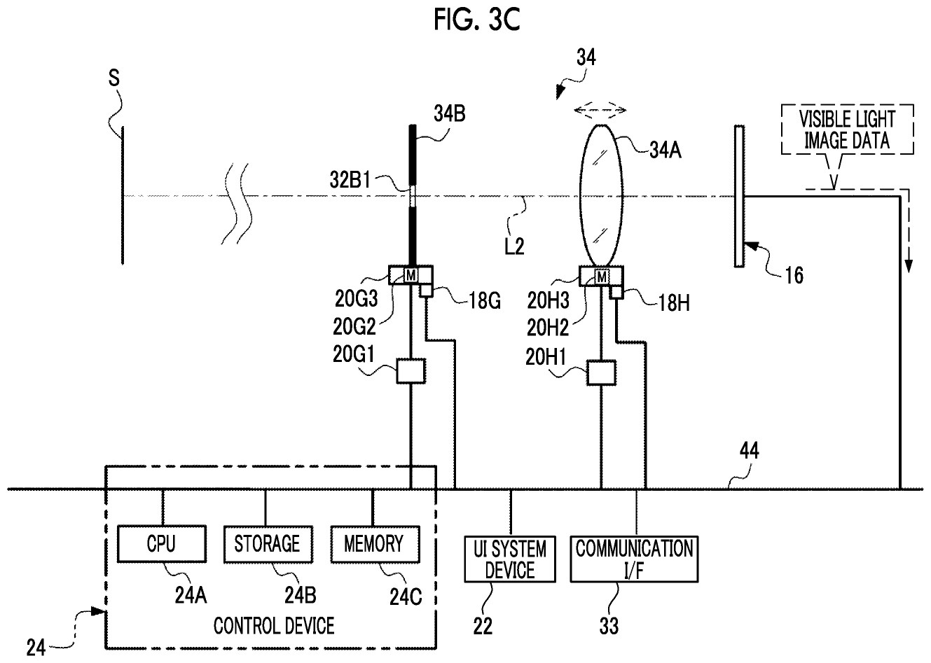

As an example, as shown in FIGS. 3A to 3C, the control device 24 includes a CPU 24A, a storage 24B, and a memory 24C, and the CPU 24A, the storage 24B, and the memory 24C are connected to a bus 44.

It should be noted that, in the example shown in FIGS. 3A to 3C, one bus is shown as the bus 44 for convenience of illustration, but a plurality of buses may be used. The bus 44 may be a serial bus or may be a parallel bus including a data bus, an address bus, a control bus, and the like.

The storage 24B stores various parameters and various programs. The storage 24B is a non-volatile storage device. Here, an EEPROM is adopted as an example of the storage 24B. The EEPROM is merely an example, and an HDD and/or SSD or the like may be applied as the storage 24B instead of the EEPROM or together with the EEPROM. In addition, the memory 24C transitorily stores various pieces of information and is used as a work memory. Examples of the memory 24C include a RAM, but the technology of the present disclosure is not limited to this, and other types of storage devices may be used.

The imaging system position sensor 18 includes a first position sensor 18A, a second position sensor 18B, a third position sensor 18C, a fourth position sensor 18D, a fifth position sensor 18E, and a sixth position sensor 18F. The first position sensor 18A, the second position sensor 18B, the third position sensor 18C, and the fourth position sensor 18D are used for the first optical system 28. In addition, the fifth position sensor 18E and the sixth position sensor 18F are used for the second optical system 32. Here, as an example of each of the first position sensor 18A, the second position sensor 18B, the third position sensor 18C, the fourth position sensor 18D, the fifth position sensor 18E, and the sixth position sensor 18F, a potentiometer is adopted.

The first position sensor 18A detects a position of the first lens group 28A on the optical axis L1. The second position sensor 18B detects a position of the second lens group 28B on the optical axis L1. The third position sensor 18C detects a position of the third lens group 28C on the optical axis L1. The fourth position sensor 18D detects the diameter of the aperture 28E1. The fifth position sensor 18E detects the diameter of the aperture 32B1. The sixth position sensor 18F detects a position of the relay lens 32A on the optical axis L1. The first position sensor 18A, the second position sensor 18B, the third position sensor 18C, the fourth position sensor 18D, the fifth position sensor 18E, and the sixth position sensor 18F are connected to the bus 44, and the CPU 24A acquires a detection result of the first position sensor 18A, a detection result of the second position sensor 18B, a detection result of the third position sensor 18C, a detection result of the fourth position sensor 18D, a detection result of the fifth position sensor 18E, and a detection result of the sixth position sensor 18F.

The imaging system motor 20 is an example of a “first drive source” according to the technology of the present disclosure, and includes a first motor 20A2, a second motor 20B2, a third motor 20C2, a fourth motor 20D2, a fifth motor 20E2, and a sixth motor 20F2. In addition, the imaging apparatus 10 includes a first motor driver 20A1, a second motor driver 20B1, a third motor driver 20C1, a fourth motor driver 20D1, a fifth motor driver 20E1, and a sixth motor driver 20F1. The first motor driver 20A1 is connected to the first motor 20A2. The second motor driver 20B1 is connected to the second motor 20B2. The third motor driver 20C1 is connected to the third motor 20C2. The fourth motor driver 20D1 is connected to the fourth motor 20D2. The fifth motor driver 20E1 is connected to the fifth motor 20E2. The sixth motor driver 20F1 is connected to the sixth motor 20F2.

The first motor driver 20A1, the second motor driver 20B1, the third motor driver 20C1, the fourth motor driver 20D1, the fifth motor driver 20E1, and the sixth motor driver 20F1 are connected to the bus 44. The first motor driver 20A1 controls the first motor 20A2 under the control of the CPU 24A. The second motor driver 20B1 controls the second motor 20B2 under the control of the CPU 24A. The third motor driver 20C1 controls the third motor 20C2 under the control of the CPU 24A. The fourth motor driver 20D1 controls the fourth motor 20D2 under the control of the CPU 24A. The fifth motor driver 20E1 controls the fifth motor 20E2 under the control of the CPU 24A. The sixth motor driver 20F1 controls the sixth motor 20F2 under the control of the CPU 24A.

The imaging apparatus 10 includes a first moving mechanism 20A3, a second moving mechanism 20B3, a third moving mechanism 20C3, a fourth moving mechanism 20D3, a fifth moving mechanism 20E3, and a sixth moving mechanism 20F3. The first moving mechanism 20A3 includes the first motor 20A2. The second moving mechanism 20B3 includes the second motor 20B2. The third moving mechanism 20C3 includes the third motor 20C2. The fourth moving mechanism 20D3 includes the fourth motor 20D2. The fifth moving mechanism 20E3 includes the fifth motor 20E2. The sixth moving mechanism 20F3 includes the sixth motor 20F2.

The first lens group 28A is connected to the first moving mechanism 20A3. The first moving mechanism 20A3 is operated by receiving the power generated by the first motor 20A2 under the control of the first motor driver 20A1 to move the first lens group 28A in the direction of the optical axis L1.

The second lens group 28B is connected to the second moving mechanism 20B3. The second moving mechanism 20B3 is operated by receiving the power generated by the second motor 20B2 under the control of the second motor driver 20B1 to move the second lens group 28B in the direction of the optical axis L1.

The third lens group 28C is connected to the third moving mechanism 20C3. The third moving mechanism 20C3 is operated by receiving the power generated by the third motor 20C2 under the control of the third motor driver 20C1 to move the third lens group 28C in the direction of the optical axis L1.

The stop 28E is connected to the fourth moving mechanism 20D3. The fourth moving mechanism 20D3 is operated by receiving the power generated by the fourth motor 20D2 under the control of the fourth motor driver 20D1 to adjust an aperture degree of the aperture 28E1 of the stop 28E.

The stop 32B is connected to the fifth moving mechanism 20E3. The fifth moving mechanism 20E3 is operated by receiving the power generated by the fifth motor 20E2 under the control of the fifth motor driver 20E1 to adjust an aperture degree of the aperture 32B1 of the stop 32B.

The relay lens 32A is connected to the sixth moving mechanism 20F3. The sixth moving mechanism 20F3 is operated by receiving the power generated by the sixth motor 20F2 under the control of the sixth motor driver 20F1 to move the relay lens 32A in the direction of the optical axis L1.

The visible light separated from the subject light by the imaging system prism 30 is incident on the third optical system 34. The third optical system 34 transmits the separated visible light and guides the separated visible light to the second image sensor 16. The third optical system 34 is disposed on the image side with respect to the imaging system prism 30 along a direction of the optical axis L2, and includes a relay lens 34A and a stop 34B. In the third optical system 34, the stop 34B and the relay lens 34A are disposed in order from the subject S side along the optical axis L2. That is, the stop 34B is disposed at a position adjacent to the relay lens 34A on the subject S side with respect to the relay lens 34A in the direction of the optical axis L2.

The stop 34B has an aperture 34B1 on the optical axis L2. The aperture 34B1 is in a conjugate positional relationship with the aperture 28E1 on the optical axis L1. The stop 34B is a movable stop in which a diameter of the aperture 34B1 can be changed. That is, a light amount of the visible light can be changed by the stop 34B. It should be noted that each of the stop 28E and the stop 34B is an independently controllable stop.

The relay lens 34A is a lens that has positive power. The relay lens 34A images the incident visible light on the light-receiving surface 16A through the stop 34B. As described above, the visible light is incident on the third optical system 34 through the stop 34B, and the third optical system 34 emits the incident visible light to the light-receiving surface 16A.

As an example, as shown in FIG. 3C, the imaging system position sensor 18 includes a seventh position sensor 18G and an eighth position sensor 18H. The seventh position sensor 18G and the eighth position sensor 18H are used for the third optical system 34. Here, as an example of each of the seventh position sensor 18G and the eighth position sensor 18H, a potentiometer is adopted.

The seventh position sensor 18G detects the diameter of the aperture 34B1. The eighth position sensor 18H detects a position of the relay lens 34A on the optical axis L2. The seventh position sensor 18G and the eighth position sensor 18H are connected to the bus 44, and the CPU 24A acquires a detection result of the seventh position sensor 18G and a detection result of the eighth position sensor 18H.

The imaging system motor 20 includes a seventh motor 20G2 and an eighth motor 20H2. In addition, the imaging apparatus 10 includes a seventh motor driver 20G1 and an eighth motor driver 20H1. The seventh motor driver 20G1 is connected to the seventh motor 20G2. The eighth motor driver 20H1 is connected to the eighth motor 20H2.

The seventh motor driver 20G1 and the eighth motor driver 20H1 are connected to the bus 44. The seventh motor driver 20G1 controls the seventh motor 20G2 under the control of the CPU 24A. The eighth motor driver 20H1 controls the eighth motor 20H2 under the control of the CPU 24A.

The imaging apparatus 10 includes a seventh moving mechanism 20G3 and an eighth moving mechanism 20H3. The seventh moving mechanism 20G3 includes the seventh motor 20G2. The eighth moving mechanism 20H3 includes the eighth motor 20H2.

The stop 34B is connected to the seventh moving mechanism 20G3. The seventh moving mechanism 20G3 is operated by receiving the power generated by the seventh motor 20G2 under the control of the seventh motor driver 20G1 to adjust an aperture degree of the aperture 34B1 of the stop 34B.

The relay lens 34A is connected to the eighth moving mechanism 20H3. The eighth moving mechanism 20H3 is operated by receiving the power generated by the eighth motor 20H2 under the control of the eighth motor driver 20H1 to move the relay lens 34A in the direction of the optical axis L2.

The imaging apparatus 10 includes a communication I/F 33, and the communication I/F 33 is connected to the bus 44. The communication I/F 33 is, for example, a network interface, and controls transmission of various pieces of information between the CPU 24A and the management device 11 through a network. Examples of the network include a WAN, such as the Internet or a public communication network.

The first image sensor 14 and the second image sensor 16 are connected to the bus 44, and the CPU 24A controls the first image sensor 14 and the second image sensor 16 to acquire the image data from each of the first image sensor 14 and the second image sensor 16.

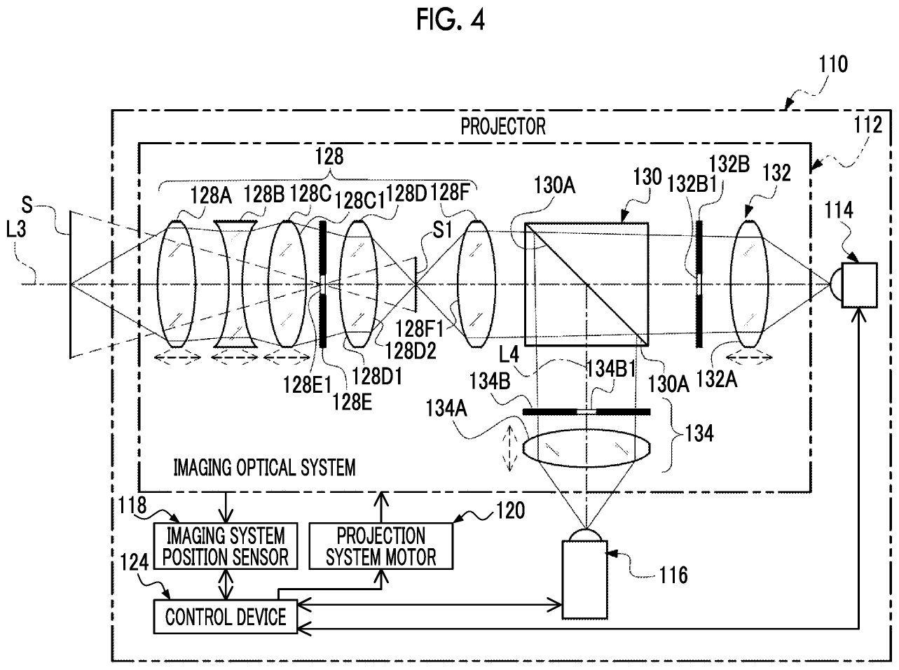

As an example, as shown in FIG. 4, the projector 110 includes a projection optical system 112, a first light source 114, a second light source 116, a projection system position sensor 118, a projection system motor 120, and a control device 124. It should be noted that the projector 110 is an example of a “projector” according to the technology of the present disclosure, and the projection optical system 112 is an example of a “second optical system” according to the technology of the present disclosure.

The first light source 114 and the second light source 116 are positioned on a subsequent stage of the projection optical system 112. The light emitted from the first light source 114 and the second light source 116 is emitted to the subject S side by the projection optical system 112. That is, the projection of the light is performed by the first light source 114 and the second light source 116.

Here, the projection optical system 112 has an optical specification corresponding to an optical specification of the imaging optical system 12. That is, as shown in FIG. 4 as an example, the projection optical system 112 is composed of an optical element corresponding to the optical element constituting the imaging optical system 12. Here, in the “corresponding optical specification” according to the technology of the present disclosure, in addition to the meaning of the same optical specification as the imaging optical system 12, the meaning of substantially the same optical specification, including an error that can be tolerated in the technical field related to the technology of the present disclosure (for example, an error in a dimension that can occur between design and manufacture), and the meaning of the optical specification having a similar relationship with the optical specification of the imaging optical system 12 are also included. Here, the “optical specification having a similar relationship with the optical specification of the imaging optical system 12” refers to, for example, the optical specification having a similar relationship in which the optical characteristics including the number of lenses constituting the lens group, an interval between the optical elements, and the size of the optical element between the imaging optical system 12 and the projection optical system 112.

As an example, as shown in FIG. 4, the projection optical system 112 includes a first optical system 128, a projection system prism 130, a second optical system 132, and a third optical system 134.

The projection optical system 112 is provided with a projection system infrared light optical path and a projection system visible light optical path. In the projection system infrared light optical path, the first optical system 128, the projection system prism 130, and the second optical system 132 are disposed in order from the subject S side along an optical axis L3. The first light source 114 is disposed on a subsequent stage of the second optical system 132.

The first light source 114 is a light source capable of emitting the long-wavelength light having a longer wavelength than the visible light. Here, the infrared light is adopted as an example of the long-wavelength light having a longer wavelength than the visible light. An example of the infrared light is light having an infrared light wavelength range of 1400 nm or more and 2600 nm or less. The first light source 114 is a laser diode, for example. Here, the laser diode has been described, but the technology of the present disclosure is not limited to this, and other types of light source, such as LED diodes, may be applied. It should be noted that the first light source 114 is an example of a “first light source” according to the technology of the present disclosure.

The second optical system 132 transmits the infrared light emitted from the first light source 114 and guides the infrared light to the projection system prism 130. More specifically, the second optical system 132 is disposed on the light source side with respect to the projection system prism 130 along a direction of the optical axis L3, and includes a relay lens 132A. The relay lens 132A is a lens that has positive power. The infrared light emitted from the first light source 114 is incident on the relay lens 132A, and the relay lens 132A transmits the incident infrared light and guides the incident infrared light to the projection system prism 130.

The projection system visible light optical path includes the optical axis L3 and an optical axis L4. The optical axis L4 is an optical axis perpendicular to the optical axis L3. In the projection system visible light optical path, the first optical system 128 and the projection system prism 130 are disposed in order from the subject S side along the optical axis L3. In the projection system visible light optical path, the third optical system 134 is disposed along the optical axis L4 on the light source side with respect to the projection system prism 130. The third optical system 134 includes a relay lens 134A and a stop 134B. In the third optical system 134, the stop 134B and the relay lens 134A are disposed in order from the subject S side along the optical axis L4. That is, the stop 134B is disposed at a position adjacent to the relay lens 134A on the subject S side with respect to the relay lens 134A in a direction of the optical axis L4.

The second light source 116 is disposed on a subsequent stage of the third optical system 134, that is, on the light source side with respect to the third optical system 134. The second light source 116 is a laser diode, for example. Here, the laser diode has been described, but the technology of the present disclosure is not limited to this, and other types of light source, such as LED diodes, may be applied. It should be noted that the second light source 116 is an example of a “second light source” according to the technology of the present disclosure.

The third optical system 134 transmits the visible light emitted from the second light source 116 and guides the visible light to the projection system prism 130 through the stop 134B. Specifically, the relay lens 134A is a lens having positive power, and guides the visible light emitted from the second light source 116 to the stop 134B.

The stop 134B has an aperture 134B1 on the optical axis L4. The aperture 134B1 is in a conjugate positional relationship with an aperture 128E1 on the optical axis L3. The stop 134B is a movable stop in which a diameter of the aperture 134B1 can be changed. That is, a light amount of the visible light can be changed by the stop 134B. It should be noted that each of a stop 128E and the stop 134B is an independently controllable stop.

As described above, the visible light is incident on the third optical system 134 from the second light source 116, and the third optical system 134 guides the incident visible light to the projection system prism 130.

The projection system prism 130 is an example of a “synthetic optical system” according to the technology of the present disclosure. The projection system prism 130 synthesizes the infrared light emitted from the first light source 114 and the visible light emitted from the second light source 116, and guides the synthesized light to the first optical system 128. The first optical system 128 transmits the infrared light and the visible light. That is, the first optical system 128 emits the light including the infrared light and the visible light synthesized by the projection system prism 130 to the subject S side.

More specifically, the projection system prism 130 synthesizes the infrared light transmitted through the second optical system 132 and the visible light transmitted through the third optical system 134 on a selective reflecting surface 130A. The projection system prism 130 transmits the infrared light and reflects the visible light. That is, the projection system prism 130 guides the infrared light to the first optical system 128 along the optical axis L3, and guides the visible light to the first optical system 128 along the optical axis L3.

It should be noted that, here, although the projection system prism 130 has been described, the technology of the present disclosure is not limited to this, and the infrared light and the visible light may be synthesized by a dichroic mirror and/or a half mirror instead of the projection system prism 130. It should be noted that, in a case in which the half mirror is used, the light having an unneeded wavelength range may be removed, by a filter, from the synthesized light.

The first optical system 128 includes a first lens group 128A, a second lens group 128B, a third lens group 128C, and a fourth lens group 128D in order from the subject S side. The first lens group 128A is a lens group having positive optical power, the second lens group 128B is a lens group having negative optical power, the third lens group 128C is a lens group having positive optical power, and the fourth lens group 128D is a lens group having positive optical power. The first optical system 128 includes the first lens group 128A as a focus lens. The second lens group 128B and the third lens group 128C are provided as a zoom lens. It should be noted that the second lens group 128B and the third lens group 128C are examples of a “second zoom lens”, a “third zoom lens”, and a “fourth zoom lens” according to the technology of the present disclosure.

The first optical system 128 consists of the first lens group 128A, the second lens group 128B, the third lens group 128C, the fourth lens group 128D, the stop 128E, and a fifth lens group 128F. Each of the first lens group 128A, the second lens group 128B, the third lens group 128C, the fourth lens group 128D, and the fifth lens group 128F consists of a plurality of lenses. It should be noted that the first lens group 128A, the second lens group 128B, the third lens group 128C, the fourth lens group 128D, the stop 128E, and the fifth lens group 128F are examples of a “second optical element” according to the technology of the present disclosure.

In the first optical system 128, the first lens group 128A, the second lens group 128B, the third lens group 128C, the fourth lens group 128D, and the fifth lens group 128F are disposed in order from the subject S side along the optical axis L3. The third lens group 128C includes an incident surface 128C1, and the fourth lens group 128D includes an emission surface 128D1 and an incident surface 128D2. The incident surface 128C1 is a surface of the third lens group 128C positioned closest to the light source side, the emission surface 128D1 is a surface of the fourth lens group 128D positioned closest to the subject S side, and the incident surface 128D2 is a surface of the fourth lens group 128D positioned closest to the light source side. The stop 128E is disposed between the incident surface 128C1 and the emission surface 128D1. In the example shown in FIG. 4, the aspect shown in which the stop 128E is disposed at a position adjacent to the fourth lens group 128D (for example, between the incident surface 128C1 and the emission surface 128D1) on the subject S side with respect to the fourth lens group 128D in the direction of the optical axis L3, but this is merely an example, and the stop 128E may be disposed in the fourth lens group 128D.

Both the first lens group 128A and the fourth lens group 128D are stationary lens groups. The stationary lens group is a lens group fixed to a light source during changing magnification. Both the second lens group 128B and the third lens group 128C are movable lens groups. The movable lens group is a lens group in which an interval from an adjacent lens group is changed by moving along the direction of the optical axis L3 during changing magnification. Each of the first lens group 128A, the third lens group 128C, the fourth lens group 128D, and the fifth lens group 128F is a lens group that has positive power, and the second lens group 128B is a lens group that has negative power. It should be noted that, here, the lens groups, such as the first lens group 128A, the second lens group 128B, the third lens group 128C, the fourth lens group 128D, and the fifth lens group 128F have been described, but the technology of the present disclosure is not limited to this. For example, at least one of the first lens group 128A, the second lens group 128B, the third lens group 128C, the fourth lens group 128D, or the fifth lens group 128F may be one lens.

In addition, the fifth lens group 128F is a stationary lens group that is immovable in the direction of the optical axis L3. Further, the fifth lens group 128F guides the synthesized light transmitted through the projection system prism 130 to the first optical system 128 as non-magnification light.

In the projector 110, the first optical system 128 realizes the adjustment of the optical disposition (hereinafter, simply referred to as “pseudo focus position”) corresponding to the focus position in the imaging apparatus 10. The adjustment of the pseudo focus position is realized by, for example, a front lens element focus method. In the front lens element focus method, the first lens group 128A is moved along the direction of the optical axis L3, so that the irradiation with the light synthesized on the subject S is performed at a pseudo focus position corresponding to the distance to the subject S. The “pseudo focus position” used herein refers to a position of the first lens group 128A on the optical axis L3 in a case of the imaging apparatus 10 in a focused state. In addition, the first lens group 128A is an example of a “second focus lens” according to the technology of the present disclosure.

It should be noted that, in the first embodiment, the front lens element focus method is adopted, but the technology of the present disclosure is not limited to this, and a whole group feeding method, an inner focus method, or a rear focus method may be adopted. The “pseudo focus position” in a case of the whole group feeding method, the inner focus method, or the rear focus method refers to a position in a focused state among the positions on the optical axis L3 of the lens or the lens group that is moved along the direction of the optical axis L3 to adjust the focus position.

The stop 128E includes an aperture 128E1, and the synthesized light passes through the aperture 128E1. The aperture 128E1 is disposed at a position at which peripheral rays of the synthesized light pass through the optical axis L3. The stop 128E is a movable stop in which a diameter of the aperture 128E1 can be changed. That is, a light amount of the synthesized light can be changed by the stop 128E.

The projection system position sensor 118 and the projection system motor 120 are connected to the projection optical system 112. The projection system position sensor 118 is a device that detects a position of the lens group, the relay lens, or the like constituting the projection optical system 112, a diameter of the aperture of the stop, or the like. The projection system motor 120 is a device that applies power to the lens group, the relay lens, or the stop that constitutes the projection optical system 112.

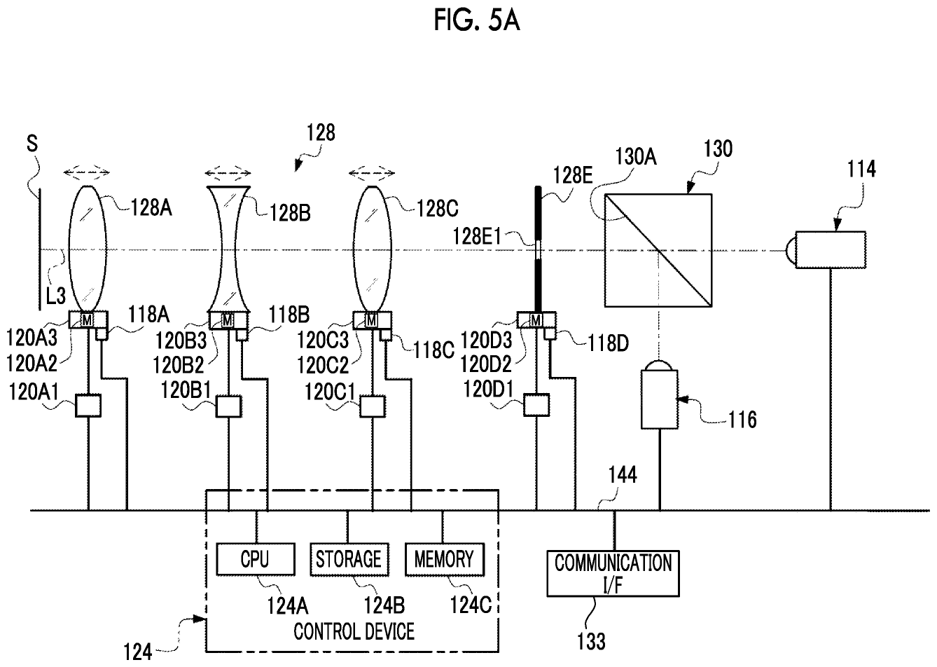

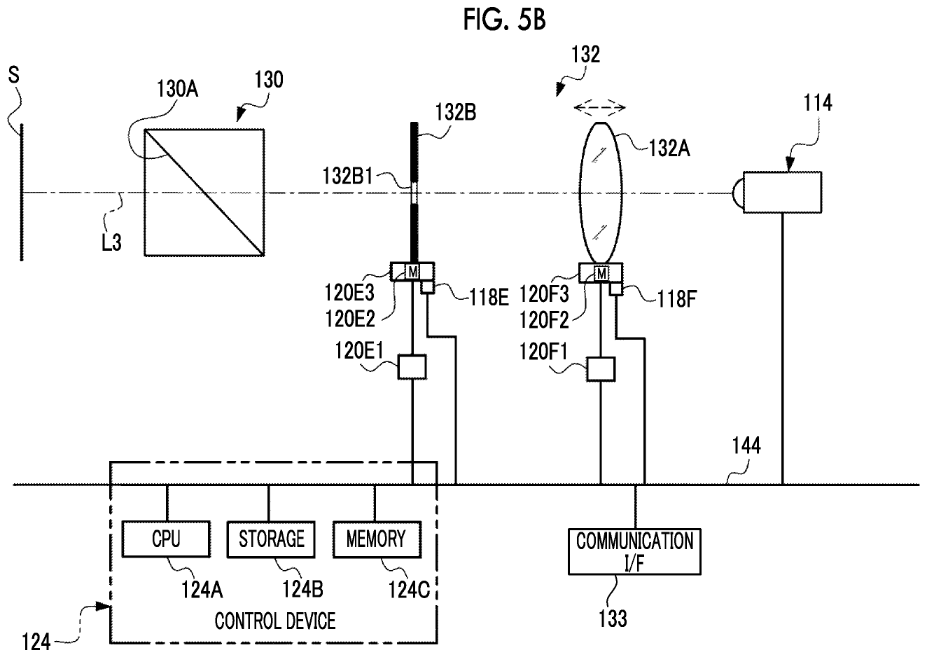

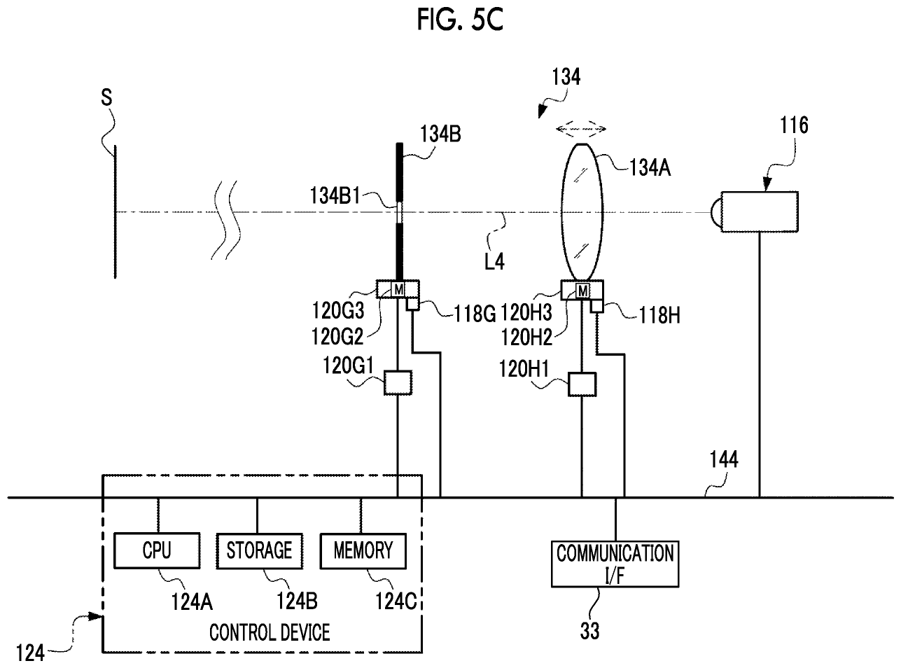

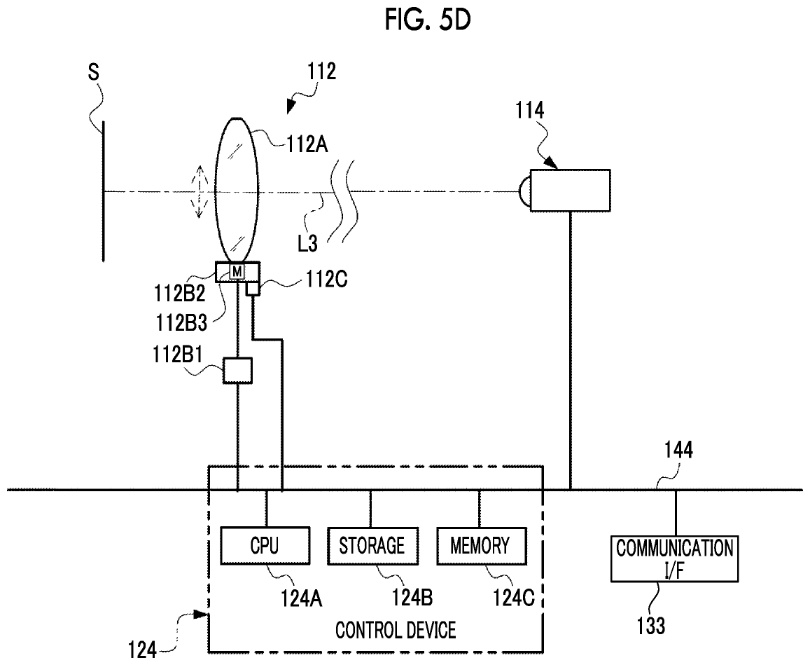

As an example, as shown in FIG. 5A, the control device 124 includes a CPU 124A, a storage 124B, and a memory 124C, and the CPU 124A, the storage 124B, and the memory 124C are connected to a bus 144.

It should be noted that, in the example shown in FIGS. 5A to 5D, one bus is shown as the bus 144 for convenience of illustration, but a plurality of buses may be used. The bus 144 may be a serial bus or may be a parallel bus including a data bus, an address bus, a control bus, and the like.

The storage 124B stores various parameters and various programs. The storage 124B is a non-volatile storage device. Here, an EEPROM is adopted as an example of the storage 124B. The EEPROM is merely an example, and an HDD and/or SSD or the like may be applied as the storage 124B instead of the EEPROM or together with the EEPROM. In addition, the memory 124C transitorily stores various pieces of information and is used as a work memory. Examples of the memory 124C include a RAM, but the technology of the present disclosure is not limited to this, and other types of storage devices may be used.

The projection system position sensor 118 includes a first position sensor 118A, a second position sensor 118B, a third position sensor 118C, a fourth position sensor 118D, a fifth position sensor 118E, and a sixth position sensor 118F. The first position sensor 118A, the second position sensor 118B, the third position sensor 118C, and the fourth position sensor 118D are used for the first optical system 128. In addition, the fifth position sensor 118E and the sixth position sensor 118F are used for the second optical system 132. Here, as an example of each of the first position sensor 118A, the second position sensor 118B, the third position sensor 118C, the fourth position sensor 118D, the fifth position sensor 118E, and the sixth position sensor 118F, a potentiometer is adopted.

The first position sensor 118A detects a position of the first lens group 128A on the optical axis L3. The second position sensor 118B detects a position of the second lens group 128B on the optical axis L3. The third position sensor 118C detects a position of the third lens group 128C on the optical axis L3. The fourth position sensor 118D detects the diameter of the aperture 128E1. The fifth position sensor 118E detects a diameter of an aperture 132B1. The sixth position sensor 118F detects a position of the relay lens 132A on the optical axis L3. The first position sensor 118A, the second position sensor 118B, the third position sensor 118C, the fourth position sensor 118D, the fifth position sensor 118E, and the sixth position sensor 118F are connected to the bus 144, and the CPU 124A acquires a detection result of the first position sensor 118A, a detection result of the second position sensor 118B, a detection result of the third position sensor 118C, a detection result of the fourth position sensor 118D, a detection result of the fifth position sensor 118E, and a detection result of the sixth position sensor 118F.

The projection system motor 120 is an example of a “second drive source” according to the technology of the present disclosure, and includes a first motor 120A2, a second motor 120B2, a third motor 120C2, a fourth motor 120D2, a fifth motor 120E2, and a sixth motor 120F2. In addition, the projector 110 includes a first motor driver 120A1, a second motor driver 120B1, a third motor driver 120C1, a fourth motor driver 120D1, a fifth motor driver 120E1, and a sixth motor driver 120F1. The first motor driver 120A1 is connected to the first motor 120A2. The second motor driver 120B1 is connected to the second motor 120B2. The third motor driver 120C1 is connected to the third motor 120C2. The fourth motor driver 120D1 is connected to the fourth motor 120D2. The fifth motor driver 120E1 is connected to the fifth motor 120E2. The sixth motor driver 120F1 is connected to the sixth motor 120F2.

The first motor driver 120A1, the second motor driver 120B1, the third motor driver 120C1, the fourth motor driver 120D1, the fifth motor driver 120E1, and the sixth motor driver 120F1 are connected to the bus 144. The first motor driver 120A1 controls the first motor 120A2 under the control of the CPU 124A. The second motor driver 120B1 controls the second motor 120B2 under the control of the CPU 124A. The third motor driver 120C1 controls the third motor 120C2 under the control of the CPU 124A. The fourth motor driver 120D1 controls the fourth motor 120D2 under the control of the CPU 124A. The fifth motor driver 120E1 controls the fifth motor 120E2 under the control of the CPU 124A. The sixth motor driver 120F1 controls the sixth motor 120F2 under the control of the CPU 124A.

The projector 110 includes a first moving mechanism 120A3, a second moving mechanism 120B3, a third moving mechanism 120C3, a fourth moving mechanism 120D3, a fifth moving mechanism 120E3, and a sixth moving mechanism 120F3. The first moving mechanism 120A3 includes the first motor 120A2. The second moving mechanism 120B3 includes the second motor 120B2. The third moving mechanism 120C3 includes the third motor 120C2. The fourth moving mechanism 120D3 includes the fourth motor 120D2. The fifth moving mechanism 120E3 includes the fifth motor 120E2. The sixth moving mechanism 120F3 includes the sixth motor 120F2.

The first lens group 128A is connected to the first moving mechanism 120A3. The first moving mechanism 120A3 is operated by receiving the power generated by the first motor 120A2 under the control of the first motor driver 120A1 to move the first lens group 128A in the direction of the optical axis L3.

The second lens group 128B is connected to the second moving mechanism 120B3. The second moving mechanism 120B3 is operated by receiving the power generated by the second motor 120B2 under the control of the second motor driver 120B1 to move the second lens group 128B in the direction of the optical axis L3.

The third lens group 128C is connected to the third moving mechanism 120C3. The third moving mechanism 120C3 is operated by receiving the power generated by the third motor 120C2 under the control of the third motor driver 120C1 to move the third lens group 128C in the direction of the optical axis L3.

The stop 128E is connected to the fourth moving mechanism 120D3. The fourth moving mechanism 120D3 is operated by receiving the power generated by the fourth motor 120D2 under the control of the fourth motor driver 120D1 to adjust an aperture degree of the aperture 128E1 of the stop 128E.

A stop 132B is connected to the fifth moving mechanism 120E3. The fifth moving mechanism 120E3 is operated by receiving the power generated by the fifth motor 120E2 under the control of the fifth motor driver 120E1 to adjust an aperture degree of the aperture 132B1 of the stop 132B.

The relay lens 132A is connected to the sixth moving mechanism 120F3. The sixth moving mechanism 120F3 is operated by receiving the power generated by the sixth motor 120F2 under the control of the sixth motor driver 120F1 to move the relay lens 132A in the direction of the optical axis L3.

In addition, as shown in FIG. 5C as an example, the projection system position sensor 118 includes a seventh position sensor 118G and an eighth position sensor 118H. The seventh position sensor 118G and the eighth position sensor 118H are used for the third optical system 134. Here, as an example of each of the seventh position sensor 118G and the eighth position sensor 118H, a potentiometer is adopted.

The seventh position sensor 118G detects the diameter of the aperture 134B1. The eighth position sensor 118H detects a position of the relay lens 134A on the optical axis L4. The seventh position sensor 118G and the eighth position sensor 118H are connected to the bus 144, and the CPU 124A acquires a detection result of the seventh position sensor 118G and a detection result of the eighth position sensor 118H.

The projection system motor 120 includes a seventh motor 120G2 and an eighth motor 120H2. In addition, the projector 110 includes a seventh motor driver 120G1 and an eighth motor driver 120H1. The seventh motor driver 120G1 is connected to the seventh motor 120G2. The eighth motor driver 120H1 is connected to the eighth motor 120H2.

The seventh motor driver 120G1 and the eighth motor driver 120H1 are connected to the bus 144. The seventh motor driver 120G1 controls the seventh motor 120G2 under the control of the CPU 124A. The eighth motor driver 120H1 controls the eighth motor 120H2 under the control of the CPU 124A.

The projector 110 includes a seventh moving mechanism 120G3 and an eighth moving mechanism 120H3. The seventh moving mechanism 120G3 includes the seventh motor 120G2. The eighth moving mechanism 120H3 includes the eighth motor 120H2. The stop 134B is connected to the seventh moving mechanism 120G3. The seventh moving mechanism 120G3 is operated by receiving the power generated by the seventh motor 120G2 under the control of the seventh motor driver 120G1 to adjust an aperture degree of the aperture 132B1 of the stop 132B. The relay lens 134A is connected to the eighth moving mechanism 120H3. The eighth moving mechanism 120H3 is operated by receiving the power generated by the eighth motor 120H2 under the control of the eighth motor driver 120H1 to move the relay lens 134A in the direction of the optical axis L4.

In addition, as shown in FIG. 5D as an example, the projection optical system 112 includes a shift lens 112A and a lens shift mechanism 112B2. The shift lens 112A changes an emission direction of the light emitted from the projector 110 by moving in a direction intersecting the optical axis L3 of the projection optical system 112.

The projection optical system 112 includes a lens shift motor driver 112B1 and the lens shift mechanism 112B2. The shift lens 112A is connected to the lens shift mechanism 112B2. The lens shift mechanism 112B2 includes a lens shift motor 112B3. The lens shift motor 112B3 is a voice coil motor, for example.

The lens shift motor 112B3 is connected to the lens shift motor driver 112B1. The lens shift motor driver 112B1 is connected to the bus 144 to control the lens shift motor 112B3 under the control of the CPU 124A. The lens shift mechanism 112B2 is operated by receiving the power generated by the lens shift motor 112B3 under the control of the CPU 124A to move the shift lens 112A in the direction intersecting the optical axis L3. Here, the direction intersecting the optical axis L3 refers to a direction perpendicular to the optical axis L3, for example.

A lens shift position sensor 112C detects a shift amount of the shift lens 112A. The lens shift position sensor 112C is connected to the bus 144, and the CPU 124A acquires a detection result of the lens shift position sensor 112C.

It should be noted that the lens shift mechanism 112B2 is an example of a “drive mechanism” according to the technology of the present disclosure, and the shift lens 112A is an example of a “third lens” according to the technology of the present disclosure.

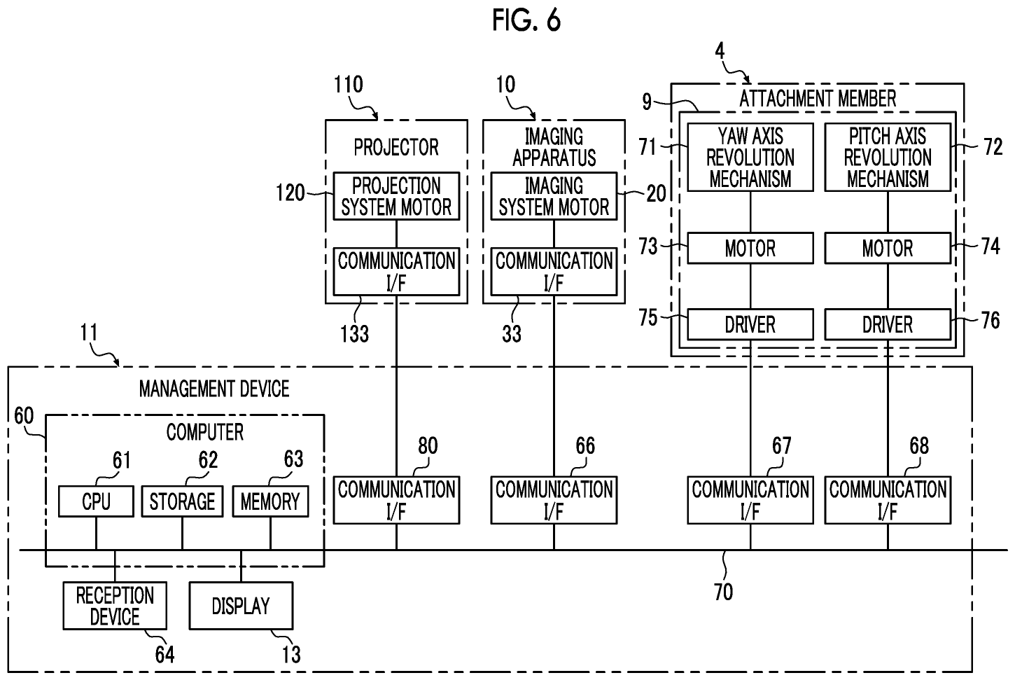

The projector 110 includes a communication I/F 133. The communication I/F 133 receives a control signal from the management device 11. The projector 110 is driven based on the control signal from the management device 11. More specifically, the communication I/F 133 is a network interface, for example. The communication I/F 133 is communicably connected to a communication I/F 80 (see FIG. 6) of the management device 11 through a network, and controls transmission of various pieces of information to and from the management device 11. For example, the communication I/F 133 requests the management device 11 to transmit information on an irradiation range of the light. The management device 11 transmits the information from the communication I/F 80 in response to the request from the projector 110.

As an example, as shown in FIG. 6, the management device 11 includes the display 13, a computer 60, a reception device 64, a communication I/F 66, a communication I/F 67, a communication I/F 68, and the communication I/F 80. In addition, the revolution mechanism 9 includes a yaw axis revolution mechanism 71, a pitch axis revolution mechanism 72, a motor 73, a motor 74, a driver 75, and a driver 76.

The computer 60 includes a CPU 61, a storage 62, and a memory 63. The CPU 61 is an example of a “processor” according to the technology of the present disclosure. Each of the display 13, the reception device 64, the CPU 61, the storage 62, the memory 63, and the communication I/Fs 66 to 68, and 80 is connected to a bus 70. It should be noted that, in the example shown in FIG. 6, one bus is shown as the bus 70 for convenience of illustration, but a plurality of buses may be used. The bus 70 may be a serial bus or may be a parallel bus including a data bus, an address bus, a control bus, and the like.

The memory 63 transitorily stores various pieces of information and is used as a work memory. Examples of the memory 63 include a RAM, but the technology of the present disclosure is not limited to this, and other types of storage devices may be used. Various programs for the management device 11 (hereinafter, simply referred to as a “program for the management device”) are stored in the storage 62. The CPU 61 reads out the management device program from the storage 62 and executes the read out management device program on the memory 63 to control the entire management device 11.

The communication I/F 66 is a network interface, for example. The communication I/F 66 is communicably connected to the communication I/F 33 of the imaging apparatus 10 through a network, and controls transmission of various pieces of information to and from the imaging apparatus 10. For example, the communication I/F 66 requests the imaging apparatus 10 to transmit a captured image, and receives the captured image transmitted from the communication I/F 33 of the imaging apparatus 10 in response to the request of transmission of the captured image.

The communication I/F 67 and the communication I/F 68 are network interfaces, for example. The communication I/F 67 is communicably connected to the driver 75 of the revolution mechanism 9 through a network. The CPU 61 controls a revolution operation of the yaw axis revolution mechanism 71 by controlling the motor 73 through the communication I/F 67 and the driver 75. The communication I/F 68 is communicably connected to the driver 76 of the revolution mechanism 9 through a network. The CPU 61 controls a revolution operation of the pitch axis revolution mechanism 72 by controlling the motor 74 through the communication I/F 68 and the driver 76.

The communication I/F 80 is a network interface, for example. The communication I/F 80 is communicably connected to the communication I/F 133 of the projector 110 through a network, and controls transmission of various pieces of information to and from the projector 110. For example, the communication I/F 80 transmits the information on the irradiation range of the light to the projector 110 to control the irradiation with the light in the projector 110.

The reception device 64 is, for example, a keyboard, a mouse, and a touch panel, and receives various instructions from the user. The CPU 61 acquires various instructions received by the reception device 64 and is operated in accordance with the acquired instructions. For example, in a case in which the reception device 64 receives the processing contents for the imaging apparatus 10, the projector 110, and/or the revolution mechanism 9, the CPU 61 operates the imaging apparatus 10, the projector 110, and/or the revolution mechanism 9 in accordance with the instruction contents received by the reception device 64.

The display 13 displays various pieces of information under the control of the CPU 61. Examples of the various pieces of information displayed on the display 13 include the contents of various instructions received by the reception device 64, and the image data received by the communication I/F 66. As described above, the computer 60 controls the display 13 to display the captured image received by the communication I/F 66.

In the revolution mechanism 9, the motor 73 generates the power under the control of the driver 75. The yaw axis revolution mechanism 71 revolves the imaging apparatus 10 and/or the projector 110 in the yaw direction by receiving the power generated by the motor 73. The motor 74 generates the power by driving under the control of the driver 76. The pitch axis revolution mechanism 72 revolves the imaging apparatus 10 and/or the projector 110 in the pitch direction by receiving the power generated by the motor 74. In addition, in the revolution mechanism 9, the projector 110 is revolved in the yaw direction or/and the pitch direction by transmitting the power through the revolution table 8A.

Here, in the imaging system 2 according to the technology of the present disclosure, in parallel with imaging by the imaging apparatus 10, the projector 110 projects the light onto the subject S. For example, in a case in which the subject S is imaged by the imaging apparatus 10 in an environment, such as at night, in which the light amount is not sufficient, the projector 110 irradiates the subject S with the light to compensate for the lack of the light amount for the subject S.

As described above, in a case in which imaging by the imaging apparatus 10 and the projection by the projector 110 are performed together, it is preferable to match a range (hereinafter, also simply referred to as an “imaging range”) imaged by the subject S, that is, the imaging apparatus 10 and a range (hereinafter, also simply referred to as the “irradiation range”) irradiated with the light by the projector 110. By matching the imaging range and the irradiation range, the light amount of the subject light indicating the subject S included in the imaging range is secured. However, in a case in which the optical specification of the imaging apparatus 10 and the optical specification of the projector 110 do not correspond to each other, it is difficult to match the imaging range and the irradiation range of the projector. It should be noted that, here, “matching the irradiation range and the imaging range” also means that, in addition to the meaning that the irradiation range and the imaging range are completely matched, the irradiation range and the imaging range correspond to each other to the extent that the subject S can be imaged by the imaging apparatus 10.

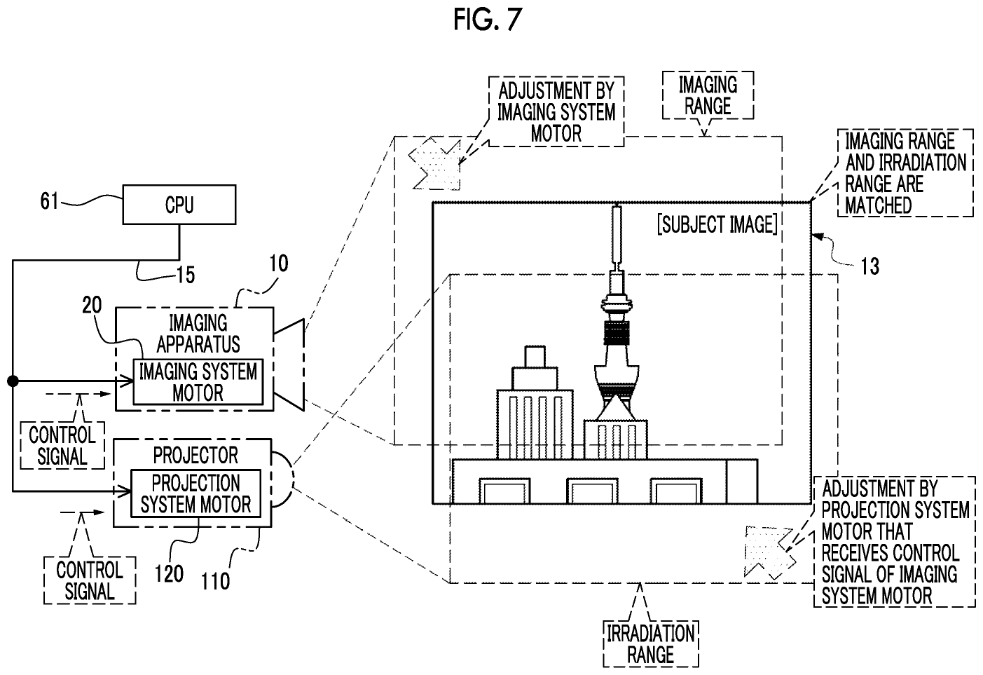

Therefore, in the imaging system 2, the imaging apparatus 10 and the projector 110 include optical systems having optical specifications corresponding to each other. In a case in which the imaging apparatus 10 and the projector 110 have corresponding optical specifications, the optical elements can be adjusted in common for the imaging apparatus 10 and the projector 110. As a result, as shown in FIG. 7 as an example, the adjustment of the imaging range in the imaging apparatus 10 and the irradiation range of the projector 110 can be easily matched.

As an example, as shown in FIG. 7, the CPU 61 is connected to the imaging system motor 20 through the communication line 15, and outputs the control signal for the imaging system motor 20 that drives the optical element in the imaging apparatus 10 through the communication line 15. The communication line 15 is branched and is also connected to the projector 110. Therefore, the CPU 61 also outputs the control signal to the projection system motor 120 that drives the optical element in the projector 110 through the communication line 15. That is, the CPU 61 controls the imaging system motor 20 by outputting the control signal to the imaging system motor 20. In addition, the CPU 61 controls the projection system motor 120 by outputting the same control signal to the projection system motor 120 as a signal for controlling the projection system motor 120. As a result, the lens group constituting the projection optical system 112 is positioned at a position corresponding to a position of the lens group constituting the imaging optical system 12. Therefore, as shown in FIG. 7 as an example, the imaging range and the irradiation range of the projector can be easily matched.

Here, even in a case in which the optical specifications of the imaging apparatus 10 and the projector 110 correspond to each other in the imaging system 2 according to the technology of the present disclosure as described above, in some cases, it is difficult to match the imaging range and the irradiation range. Examples thereof include a case in which the relative disposition of the imaging apparatus 10 and the projector 110 (for example, an angle of the optical axis and/or a distance between the devices) is significantly deviated from a predetermined condition due to aged deterioration, initial failure, or the like.

Therefore, in view of such circumstances, in the imaging system 2, the storage 62 stores an irradiation range adjustment processing program 62B, and the CPU 61 reads out the irradiation range adjustment processing program 62B from the storage 62 and executes the read out irradiation range adjustment processing program 62B on the memory 63.

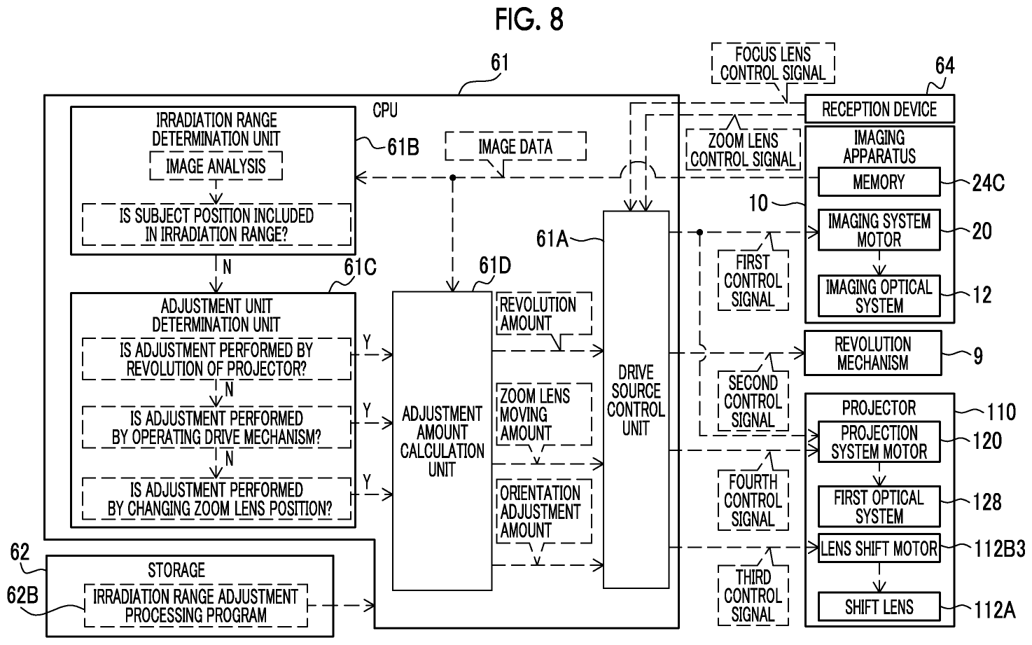

As an example, as shown in FIG. 8, the CPU 61 executes the irradiation range adjustment processing program 62B on the memory 63 to be operated as a drive source control unit 61A, an irradiation range determination unit 61B, an adjustment unit determination unit 61C, and an adjustment amount calculation unit 61D.

The reception device 64 receives an instruction (hereinafter, referred to as an “imaging system control instruction”) related to the control of the imaging system, such as a focus control and a zoom control for the imaging apparatus 10, from the user, and outputs a signal (hereinafter, referred to as an “imaging system control signal”) in accordance with the received imaging system control instruction to the drive source control unit 61A. The drive source control unit 61A acquires an imaging system optical element control signal from the reception device 64. For example, the drive source control unit 61A acquires a focus lens control signal and a zoom lens control signal as the imaging system optical element control signal from the reception device 64. The focus lens control signal is a signal for controlling the focus lens, that is, the first lens group 28A as an example, and the zoom lens control signal is a signal for controlling the zoom lens, that is, the first optical system 28 (hereinafter, also referred to as an “imaging system zoom lens”).

The drive source control unit 61A outputs a first control signal to the imaging system motor 20 of the imaging apparatus 10 based on the imaging system optical element control signal acquired from the reception device 64. In addition, the drive source control unit 61A outputs the first control signal to the projection system motor 120 of the projector 110 based on the imaging system optical element control signal acquired from the reception device 64. It should be noted that the first control signal is an example of a “control signal” according to the technology of the present disclosure.

The imaging system motor 20 drives the optical element of the imaging optical system 12 based on the first control signal. In addition, the projection system motor 120 drives the optical element of the projection optical system 112 based on the first control signal. The imaging apparatus 10 images the subject light in a state in which the optical system is controlled based on the first control signal in the imaging apparatus 10 and the projector 110. The image data obtained by being imaged by the first image sensor 14 or the second image sensor 16 of the imaging apparatus 10 is stored in the memory 24C.

The irradiation range determination unit 61B acquires the image data stored in the memory 24C. In addition, the irradiation range determination unit 61B performs image analysis processing on the acquired image data to detect the subject S and the irradiation range by the projector 110. Further, the irradiation range determination unit 61B determines whether or not the subject S is included in the irradiation range based on a detection result.

In a case in which the irradiation range determination unit 61B determines that a subject position is not included in the irradiation range, the adjustment unit determination unit 61C determines an adjustment unit required to adjust the irradiation range. Here, the adjustment unit refers to, for example, the revolution mechanism 9, the shift lens 112A, and the first optical system 128.

First, the adjustment unit determination unit 61C specifies a positional relationship between the imaging range and the irradiation range based on a result of the image analysis processing, and determines whether or not to adjust the irradiation range by revolving the projector 110 based on the specified positional relationship based on the determination result by the irradiation range determination unit 61B. In a case in which a negative determination is made, the adjustment unit determination unit 61C determines whether or not to operate the lens shift mechanism 112B2 of the projector 110 to perform the adjustment based on the positional relationship between the imaging range and the irradiation range. In a case in which a negative determination is made, the adjustment unit determination unit 61C determines to change the position of the zoom lens of the projector 110, that is, the first optical system 128 (hereinafter, also referred to as a “projection system zoom lens”) to adjust the irradiation range.

In a case in which a positive determination is made in the adjustment unit determination unit 61C, the adjustment amount calculation unit 61D calculates an adjustment amount in accordance with each adjustment unit based on the determination results. Specifically, the adjustment amount calculation unit 61D calculates the adjustment amount in accordance with each adjustment unit based on the positional relationship between the imaging range and the irradiation range. Here, the adjustment amount refers to the adjustment amount by each adjustment unit required to match the irradiation range and the imaging range. That is, the adjustment amount calculation unit 61D calculates a deviation amount between the imaging range and the irradiation range based on the positional relationship between the imaging range and the irradiation range, and calculates the adjustment amount required to eliminate the calculated deviation amount.

In a case in which the adjustment is performed by the revolution mechanism 9, the adjustment amount calculation unit 61D calculates an amount of revolving the projector 110 by the revolution mechanism 9, that is, the revolution direction and a revolution angle (hereinafter, also referred to as a “revolution amount”) based on the positional relationship between the imaging range and the irradiation range, and outputs the calculated revolution amount to the drive source control unit 61A. In addition, in a case in which the lens shift mechanism 112B2 of the projector 110 is operated to perform the adjustment, the adjustment amount calculation unit 61D calculates an orientation adjustment amount based on the positional relationship between the imaging range and the irradiation range, and outputs the calculated orientation adjustment amount to the drive source control unit 61A. Here, the orientation adjustment amount is the shift amount in the direction intersecting the optical axis of the optical element by the lens shift mechanism 112B2. Further, in a case in which the irradiation range is adjusted by moving the projection system zoom lens, the adjustment amount calculation unit 61D calculates a moving amount (hereinafter, also referred to as a “zoom lens moving amount”) of the projection system zoom lens based on the positional relationship between the imaging range and the irradiation range, and outputs the calculated zoom lens moving amount to the drive source control unit 61A.

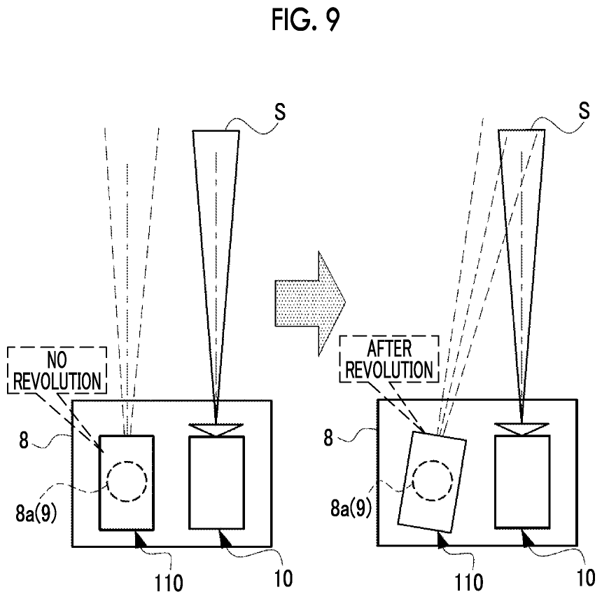

In a case in which the revolution amount is acquired from the adjustment amount calculation unit 61D, the drive source control unit 61A outputs a second control signal indicating the revolution amount to the revolution mechanism 9. As an example, as shown in FIG. 9, the revolution mechanism 9 revolves the projector 110 in the revolution direction and at the revolution angle of the projector 110 determined in response to a second control signal input from the drive source control unit 61A. As a result, the irradiation range and the imaging range are matched.

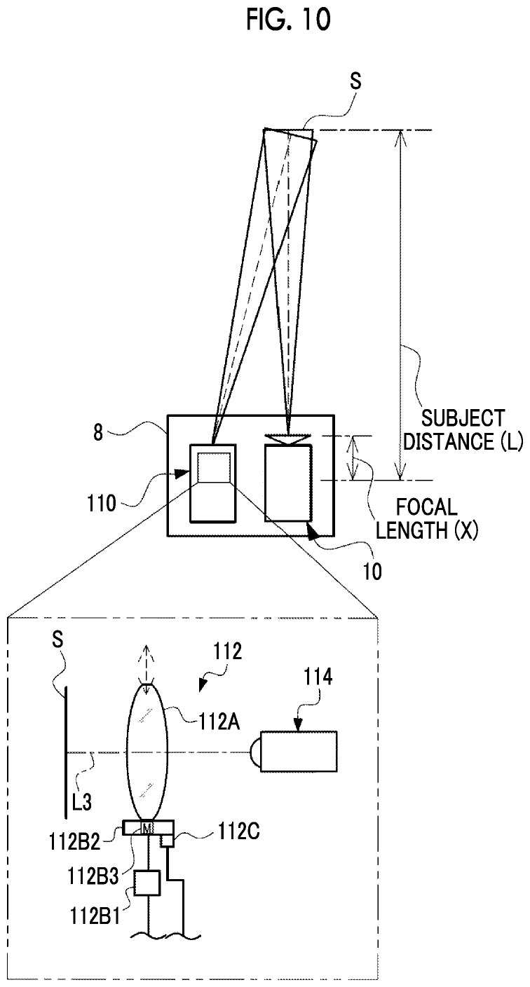

In a case in which the orientation adjustment amount is acquired from the adjustment amount calculation unit 61D, the drive source control unit 61A outputs a third control signal indicating the orientation adjustment amount to the lens shift motor 112B3 of the projector 110. As an example, as shown in FIG. 10, the projection system motor 120 is operated in response to the third control signal input from the drive source control unit 61A, and moves the shift lens 112A in the direction intersecting the optical axis L3. As a result, the projection direction of the projector 110 is changed, and the irradiation range and the imaging range are matched.

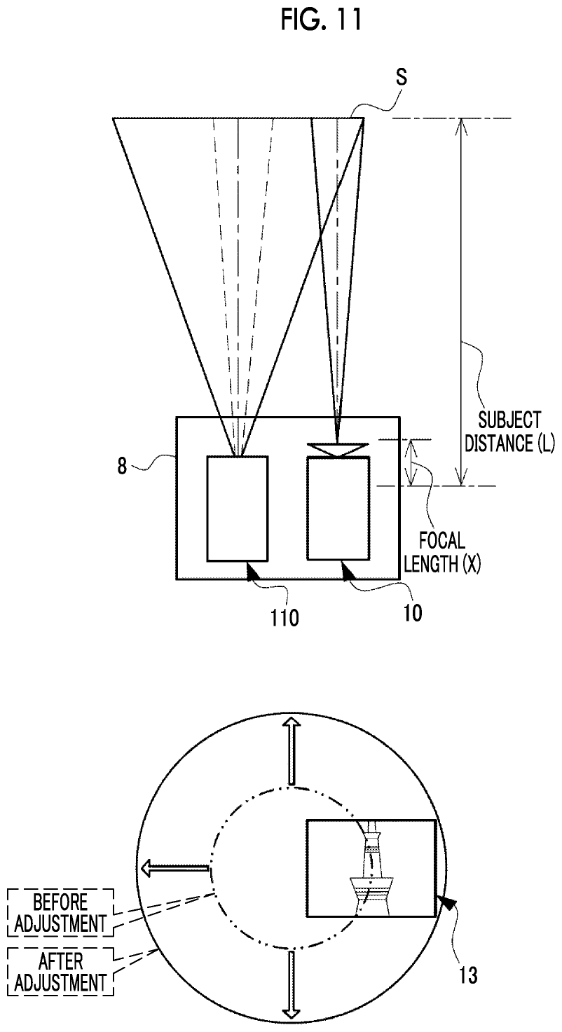

In a case in which the zoom lens moving amount is acquired from the adjustment amount calculation unit 61D, the drive source control unit 61A outputs a fourth control signal indicating the zoom lens moving amount to the projection system motor 120 of the projector 110. As an example, as shown in FIG. 11, the projection system motor 120 adjusts the position of the projection system zoom lens in accordance with the zoom lens moving amount determined in response to the fourth control signal. Specifically, by changing the positional relationship between the first lens group 28A, the second lens group 28B, the third lens group 28C, the fourth lens group 28D, and the fifth lens group 28F in accordance with the zoom lens moving amount, as shown in FIG. 11 as an example, the irradiation range is expanded and the imaging range is included in the irradiation range.

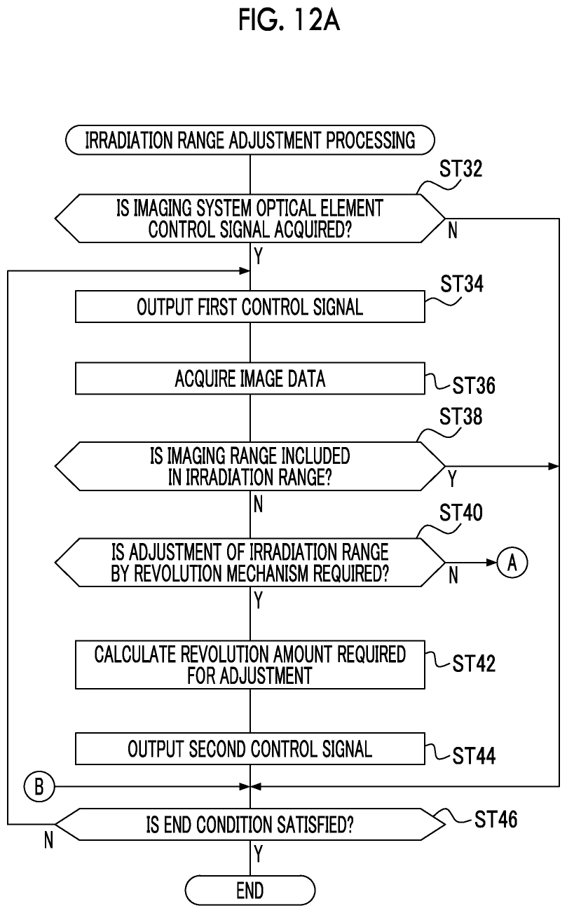

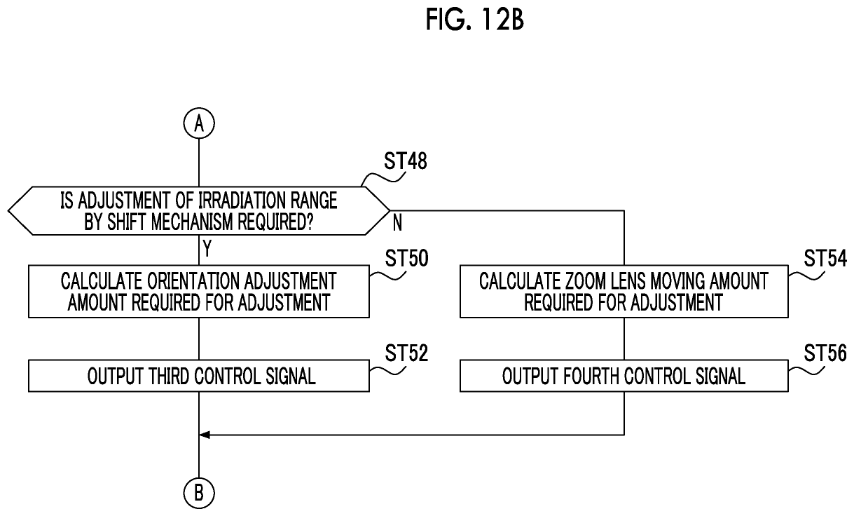

Next, an action of a part according to the technology of the present disclosure in the first embodiment will be described with reference to FIGS. 12A and 12B. FIGS. 12A and 12B show examples of a flow of the irradiation range adjustment processing executed by the CPU 61 of the management device 11 in accordance with the irradiation range adjustment processing program 62B. The flow of the irradiation range adjustment processing shown in FIGS. 12A and 12B is an example of a “control method of the imaging system” according to the technology of the present disclosure.

As an example, in the irradiation range adjustment processing shown in FIG. 12A, first, in step ST32, the drive source control unit 61A determines whether or not the imaging system optical element control signal is acquired from the reception device 64. In a case in which the imaging system optical element control signal is not acquired from the reception device 64 in step ST32, a negative determination is made, and the irradiation range adjustment processing proceeds to step ST46. In a case in which the imaging system optical element control signal is acquired from the reception device 64 in step ST32, a positive determination is made, and the irradiation range adjustment processing proceeds to step ST34.

In step ST34, the drive source control unit 61A outputs the first control signal to the imaging system motor 20 of the imaging apparatus 10 and the projection system motor 120 of the projector 110. Thereafter, the irradiation range adjustment processing proceeds to step ST36.

In step ST36, the irradiation range determination unit 61B acquires the image data from the memory 24C of the imaging apparatus 10. Thereafter, the irradiation range adjustment processing proceeds to step ST38.

In step ST38, the irradiation range determination unit 61B specifies the positional relationship between the imaging range and the irradiation range based on the image data acquired in step ST36, and determines whether or not the imaging range is included in the irradiation range based on the specified positional relationship between the imaging range and the irradiation range. In step ST38, in a case in which the imaging range is included in the irradiation range, a positive determination is made, and the irradiation range adjustment processing proceeds to step ST46. In a case in which the imaging range is not included in the irradiation range in step ST38, a negative determination is made, and the irradiation range adjustment processing proceeds to step ST40.

In step ST40, the adjustment unit determination unit 61C determines whether or not the adjustment of the irradiation range by the revolution mechanism 9 is required based on the positional relationship between the imaging range and the irradiation range. In a case in which the adjustment by the revolution mechanism 9 is required in step ST40, a positive determination is made, and the irradiation range adjustment processing proceeds to step ST42. In a case in which the adjustment by the revolution mechanism 9 is not required in step ST42, a negative determination is made, and the irradiation range adjustment processing proceeds to step ST48 shown in FIG. 12B.

In step ST42, the adjustment amount calculation unit 61D calculates the revolution amount required to adjust the irradiation range based on the positional relationship between the imaging range and the irradiation range. Thereafter, the irradiation range adjustment processing proceeds to step ST44.

In step ST44, the drive source control unit 61A outputs the second control signal corresponding to the revolution amount calculated by the adjustment amount calculation unit 61D to the revolution mechanism 9. Thereafter, the irradiation range adjustment processing proceeds to step ST46.

As an example, as shown in FIG. 12B, in step ST48, the adjustment unit determination unit 61C determines whether or not the adjustment of the irradiation range by the lens shift mechanism 112B2 is required based on the positional relationship between the imaging range and the irradiation range. In a case in which the adjustment of the irradiation range by the lens shift mechanism 112B2 is required in step ST48, a positive determination is made, and the irradiation range adjustment processing proceeds to step ST50. In a case in which the adjustment of the irradiation range by the lens shift mechanism 112B2 is not required in step ST48, a negative determination is made, and the irradiation range adjustment processing proceeds to step ST54.

In step ST50, the adjustment amount calculation unit 61D calculates the orientation adjustment required for the adjustment by the lens shift mechanism 112B2 based on the positional relationship between the imaging range and the irradiation range. Thereafter, the irradiation range adjustment processing proceeds to step ST52.

In step ST52, the drive source control unit 61A outputs the third control signal in accordance with the orientation adjustment amount acquired from the adjustment amount calculation unit 61D to the lens shift motor 112B3 of the projector 110. Thereafter, the irradiation range adjustment processing proceeds to step ST46 shown in FIG. 12A as an example.

In step ST54, the adjustment amount calculation unit 61D calculates the zoom lens moving amount required to adjust the irradiation range based on the positional relationship between the imaging range and the irradiation range. The irradiation range adjustment processing proceeds to step ST56.

In step ST56, the drive source control unit 61A outputs the fourth control signal in accordance with the zoom lens moving amount calculated in step ST54 to the projection system motor 120 of the projector 110. Thereafter, the irradiation range adjustment processing proceeds to step ST46 shown in FIG. 12A as an example.

In step ST46, the drive source control unit 61A determines whether or not a condition for ending the irradiation range adjustment processing (hereinafter, referred to as an “end condition”) is satisfied. Examples of the end condition include a condition that the reception device 64 receives an instruction to end the irradiation range adjustment processing. In a case in which the end condition is not satisfied in step ST46, a negative determination is made, and the irradiation range adjustment processing proceeds to step ST32. In a case in which the end condition is satisfied in step ST46, a positive determination is made, and the irradiation range adjustment processing ends.

As described above, the imaging system 2 includes the imaging apparatus 10 comprising the imaging optical system 12 and the projector 110 comprising the projection optical system 112, and the imaging optical system 12 and the projection optical system 112 have the optical specifications corresponding to each other. Therefore, it is easier to accurately match both the irradiation range and the imaging range as compared with a case in which the optical specification of the imaging optical system 12 and the optical specification of the projection optical system 112 do not correspond to each other.

In the imaging system 2, the drive source control unit 61A controls the imaging system motor 20 that drives the imaging optical system 12, and the projection system motor 120 that drives the projection optical system 112. Therefore, both the irradiation range and the imaging range can be accurately matched as compared with a case in which both the irradiation range and the imaging range are manually matched.

In the imaging system 2, the drive source control unit 61A controls the projection system motor 120 by outputting the signal for controlling the imaging system motor 20 that drives the imaging optical system 12 to the projection system motor 120 as the signal for controlling the projection system motor 120 that drives the projection optical system 112. Therefore, both the irradiation range and the imaging range can be accurately matched as compared with a case in which both the irradiation range and the imaging range are manually matched.

In the imaging system 2, even in a case in which the imaging optical system 12 and the projection optical system 112 have lenses as the optical element, the disposition of the lens of the projection optical system 112 is adjusted based on the control signal for the imaging optical system 12. Therefore, it is easier to control the optical systems of the imaging apparatus 10 and the projector 110 as compared with a case in which the positions of the lenses of the imaging optical system 12 and the projection optical system 112 are adjusted separately, and it is possible to perform highly accurate imaging in which the irradiation range and the imaging range are matched.

In the imaging system 2, the lens provided in the imaging optical system 12 includes the second lens group 28B and the third lens group 28C as the zoom lens, and the lens provided in the projection optical system 112 includes the second lens group 128B and the third lens group 128C as the zoom lens. Moreover, an adjustment mechanism of the projection optical system 112 matches the positions of the second lens group 128B and the third lens group 128C in the projection optical system 112 to the positions corresponding to the second lens group 28B and the third lens group 28C in the imaging optical system 12 of which the position is adjusted by the adjustment mechanism of the imaging optical system 12, based on the control signal. Therefore, it is easier to perform a control of changing magnification of each of the imaging apparatus 10 and the projector 110 as compared with a case in which the position of the zoom lens of the imaging optical system 12 and the position of the zoom lens of the projection optical system 112 are adjusted separately, and it is possible to perform highly accurate imaging in which the irradiation range and the imaging range are matched.

In addition, the lens provided in the imaging optical system 12 includes the first lens group 28A as the focus lens, and the lens provided in the projection optical system 112 includes the first lens group 128A as the focus lens. Moreover, the adjustment mechanism of the projection optical system 112 matches the position of the first lens group 128A in the projection optical system 112 to the position corresponding to the first lens group 28A in the imaging optical system 12 of which the position is adjusted by the adjustment mechanism of the imaging optical system 12, based on the control signal. Therefore, it is easier to perform the focus control of each of the imaging apparatus 10 and the projector 110 as compared with a case in which the position of the focus lens of the imaging optical system 12 and the position of the focus lens of the projection optical system 112 are adjusted separately, and it is possible to perform highly accurate imaging in which the irradiation range and the imaging range are matched.

It should be noted that, in the first embodiment, the form example has been described in which the imaging optical system 12 includes the first lens group 28A as the focus lens, and includes the second lens group 28B and the third lens group 28C as the zoom lens, but the technology of the present disclosure is not limited to this, and the imaging optical system 12 may include any of the focus lens or the zoom lens. For example, in a case in which the imaging optical system 12 includes only the focus lens of the focus lens and the zoom lens, the projection optical system 112 need only also include only the focus lens of the focus lens and the zoom lens. In a case in which the imaging optical system 12 includes only the zoom lens of the focus lens and the zoom lens, the projection optical system 112 need only also include only the zoom lens of the focus lens and the zoom lens. Also in this case, the same effect as described above can be expected.

In the imaging system 2, the control of the disposition of the optical elements of the imaging optical system 12 and the projection optical system 112 by the drive source control unit 61A is performed, and then the drive source control unit 61A further adjusts the irradiation range of the projector 110 to match the imaging range and the irradiation range, so that it is possible to perform highly accurate imaging in which the irradiation range and the imaging range are matched, as compared with a case in which the adjustment of the irradiation range is not performed.

In the imaging system 2, the irradiation range is adjusted based on the image data acquired by the imaging apparatus 10. Therefore, as compared with a case in which the irradiation range is adjusted without using the image data, it is possible to perform highly accurate imaging in which the irradiation range and the imaging range are matched.

In the imaging system 2, the control signals of the imaging optical system 12 and the projection optical system 112 are shared, and then the lens shift mechanism 112B2 is operated to adjust the irradiation range. Therefore, as compared with a case in which the control signals are not shared, it is easy to adjust the irradiation range, and it is possible to perform highly accurate imaging in which the irradiation range and the imaging range are matched.

In the imaging system 2, the control signals of the imaging optical system 12 and the projection optical system 112 are shared, and then the revolution mechanism 9 is operated to adjust the irradiation range. Therefore, as compared with a case in which the control signals are not shared, it is easy to adjust the irradiation range, and it is possible to perform highly accurate imaging in which the irradiation range and the imaging range are matched.

In the imaging system 2, the control signals of the imaging optical system 12 and the projection optical system 112 are shared, and then the position of the projection system zoom lens is changed to adjust the irradiation range. Therefore, as compared with a case in which the control signals are not shared, it is easy to adjust the irradiation range, and it is possible to perform highly accurate imaging in which the irradiation range and the imaging range are matched.

In addition, in the imaging system 2, the subject light is separated into the visible light and the long-wavelength light having a longer wavelength than the visible light by the imaging system prism 30, the subject S imaged for the visible light by the second image sensor 16, and the subject S is imaged for the long-wavelength light having a longer wavelength than the visible light by the first image sensor 14. Therefore, it is possible to simultaneously obtain the image showing the subject S for the visible light and the image showing the subject S for the long-wavelength light having a longer wavelength than the visible light.

In the imaging system 2, even in a case in which the imaging apparatus 10 includes a plurality of optical systems that image light having a plurality of wavelengths and the projector 110 includes a plurality of optical systems that performs the irradiation with light having a plurality of wavelengths, the signal for controlling the imaging optical system 12 of the imaging apparatus 10 is shared with the projection optical system 112 of the projector 110. Therefore, as compared with a case in which the imaging optical system 12 and the projection optical system 112 are controlled respectively, it is easy to adjust the optical systems of the imaging apparatus 10 and the projector 110, and it is possible to perform highly accurate imaging in which the irradiation range and the imaging range are matched, even in a case in which the irradiation and imaging with the light having a plurality of wavelengths.

In addition, in the imaging system 2, in the imaging optical system 12 and the projection optical system 112, branched and synthetic optical systems using the imaging system prism 30 and the projection system prism 130 are used, respectively. Therefore, the number of optical elements, which are control targets, can be reduced, and it is easy to adjust the optical elements of the imaging optical system 12 and the projection optical system 112 as compared with a case in which branched and synthetic optical systems are not provided. In addition, since the number of optical elements can be reduced, the reduction in the size and/or the weight of the imaging apparatus 10 and the projector 110 can be realized.

In addition, in the imaging system 2, as the long-wavelength light which is the infrared light, the light in the infrared light wavelength range of 1400 nm or more and 2600 nm or less and in a wavelength range that has a relatively little influence on human eyes is used, so that the output of the infrared light can be increased as compared with a case in which the infrared light in other wavelength ranges is used.

It should be noted that, in the first embodiment, the form example has been described in which the projection and imaging of the subject S using the light in two types of wavelength ranges of the infrared light and the visible light are realized, but the technology of the present disclosure is not limited to this. For example, light in one type of wavelength ranges or three or more types of wavelength ranges may be used, or the irradiation and imaging may be performed using light having different wavelengths among the light beams classified into the same type of wavelength range.

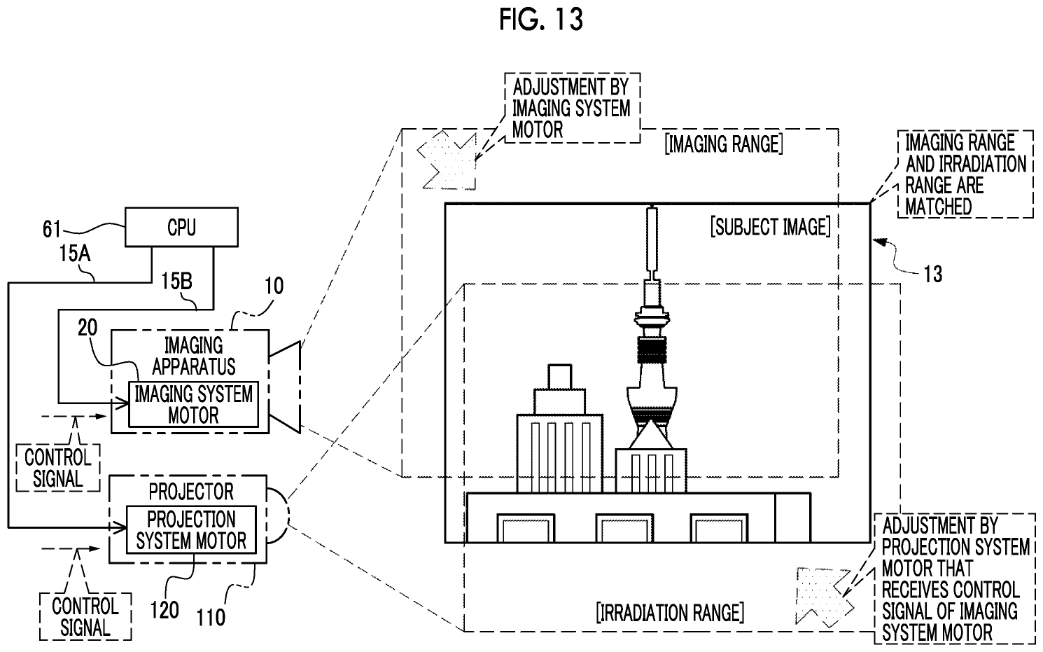

In addition, in the first embodiment, the form example has been described in which the communication line 15 is branched in the middle in a case in which the control signal is transmitted from the drive source control unit 61A to the imaging apparatus 10 and the projector 110 through the communication line 15, but the technology of the present disclosure is not limited to this. As an example, as shown in FIG. 13, a configuration may be adopted in which two communication lines 15A and 15B are connected from the management device 11 to the imaging apparatus 10 and the projector 110. The control signals for controlling the imaging system motor 20 and the projection system motor 120 are output from the drive source control unit 61A of the management device 11 through the communication lines 15A and 15B.

In addition, in the first embodiment, the form example has been described in which the infrared light has the wavelength range of 1400 nm or more and 2600 nm or less, but the technology of the present disclosure is not limited to this. Examples of the infrared light may include light in a near-infrared light wavelength range including 1550 nm. By performing imaging using the light in a near-infrared light wavelength range including 1550 nm and the visible light, visual information of both the light in the near-infrared light wavelength range including 1550 nm and the visible light is obtained, and it is possible to perform imaging that is not easily affected by scattered particles in the atmosphere as compared with a case in which light on a shorter wavelength side than the near-infrared light wavelength range including 1550 nm is imaged as the infrared light.

Further, examples of the infrared light include light in a near-infrared light wavelength range of 750 nm or more and 1000 nm or less. Since the infrared light is the light in the near-infrared light wavelength range having a wavelength range of 750 nm or more and 1000 nm or less, the light in the near-infrared light wavelength range can be detected without using an InGaAs sensor.

It should be noted that, here, the long-wavelength light having a longer wavelength than about 750 nm is adopted as the near-infrared light, but this is merely an example, and the technology of the present disclosure is not limited to this. That is, since the wavelength range of the near-infrared light has various interpretations depending on theories and the like, the wavelength range defined as the wavelength range of the near-infrared light need only be determined in accordance with the application of the imaging system 2. In addition, the same applies to the wavelength range of the visible light.

### Second Embodiment

In the first embodiment, the form example has been described in which the irradiation range is adjusted based on the image data acquired by the imaging apparatus 10. However, in a second embodiment, a form example will be described in which the irradiation range is adjusted based on information on the distance to the subject S and information on the disposition of the projector 110 and the imaging apparatus 10. It should be noted that, in the second embodiment, the components different from the components described in the first embodiment will be designated by the same reference numerals, and description thereof will be omitted.

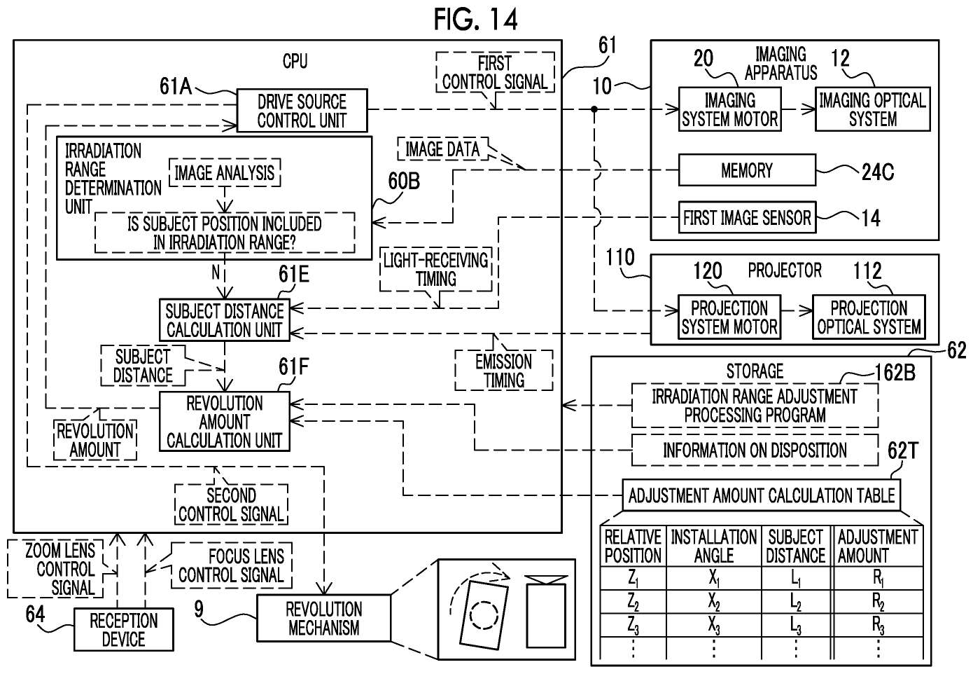

As an example, as shown in FIG. 14, the CPU 61 executes an irradiation range adjustment processing program 162B on the memory 63 to be operated as the drive source control unit 61A, the irradiation range determination unit 61B, a subject distance calculation unit 61E, and a revolution amount calculation unit 61F.

The subject distance calculation unit 61E acquires a light-receiving timing of the infrared light from the first image sensor 14 in a case in which a negative determination is made in the determination of whether or not the subject position is included in the irradiation range by the irradiation range determination unit 61B. In addition, the subject distance calculation unit 61E acquires an emission timing of the infrared light from the projector 110. The subject distance calculation unit 61E calculates the distance to the subject S from the imaging apparatus 10 based on a time required from the irradiation with the infrared light to the reception of the infrared light included in the subject light by the first image sensor 14, and a light speed. For example, in a case in which the distance to the subject S, which is a distance measurement target, is denoted by “L”, the light speed is denoted by “c”, and the time required from the emission of the infrared light to the reception of the reflected light by the first image sensor 14 is denoted by “t”, the distance L is calculated in accordance with an expression “L=c×t×0.5”. In this case, the first image sensor 14 is a so-called TOF image sensor. The subject distance calculation unit 61E calculates the information on the distance to the subject S (hereinafter, may be simply referred to as “information on the distance”) based on the acquired emission timing signal and light-receiving timing signal, and the calculation expression.

The revolution amount calculation unit 61F acquires the information on the distance from the subject distance calculation unit 61E. In addition, the revolution amount calculation unit 61F acquires the information on the disposition of the imaging apparatus 10 and the projector 110 (hereinafter, simply referred to as “information on the disposition”) from the storage 62. The information on the disposition includes information on a relative distance, a front-back misregistration, or a relative angle of the imaging apparatus 10 and the projector 110. It should be noted that, here, the form example has been described in which the information on the disposition is the information stored in the storage 62 in advance, but the technology of the present disclosure is not limited to this, and the information on the disposition may be information input by the user through the reception device 64.

Further, the revolution amount calculation unit 61F reads out an adjustment amount calculation table 62T from the storage 62. The revolution amount calculation unit 61F calculates the revolution amount of the revolution mechanism 9 based on the information on the distance, the information on the disposition, and the adjustment amount calculation table 62T. Specifically, as shown in FIG. 14, as an example, in the adjustment amount calculation table 62T, the revolution amount corresponding to the relative position, the relative angle, and the distance to the subject S of the projector 110 and the imaging apparatus 10 is obtained.

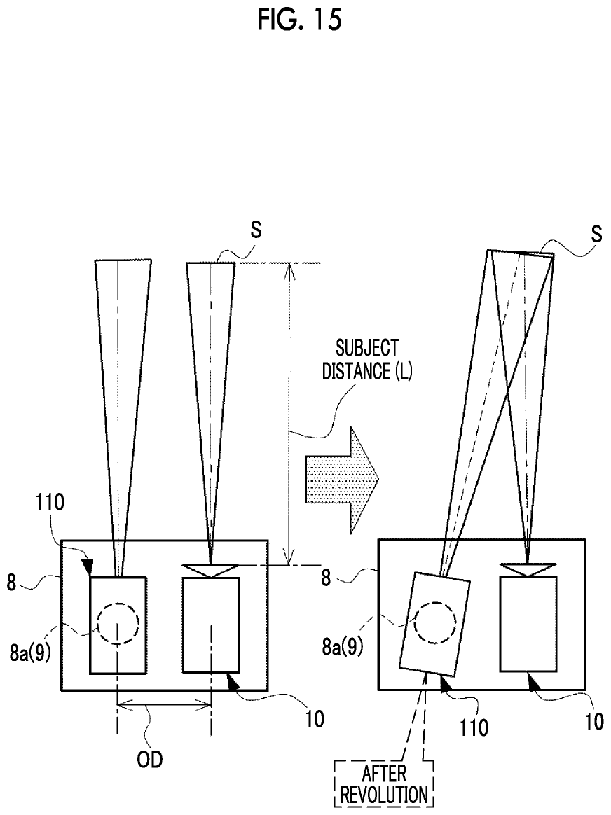

The revolution amount calculation unit 61F outputs the information on the revolution amount corresponding to the calculated revolution amount to the drive source control unit 61A. The drive source control unit 61A outputs the second control signal to the revolution mechanism 9 based on the information on the revolution amount. As an example, as shown in FIG. 15, the revolution mechanism 9 that receives the second control signal performs the revolution operation in accordance with a relative distance OD and the subject distance L, and the projector 110 is revolved by the revolution mechanism 9. As a result, the irradiation range by the projector 110 and the imaging range by the imaging apparatus 10 are matched.

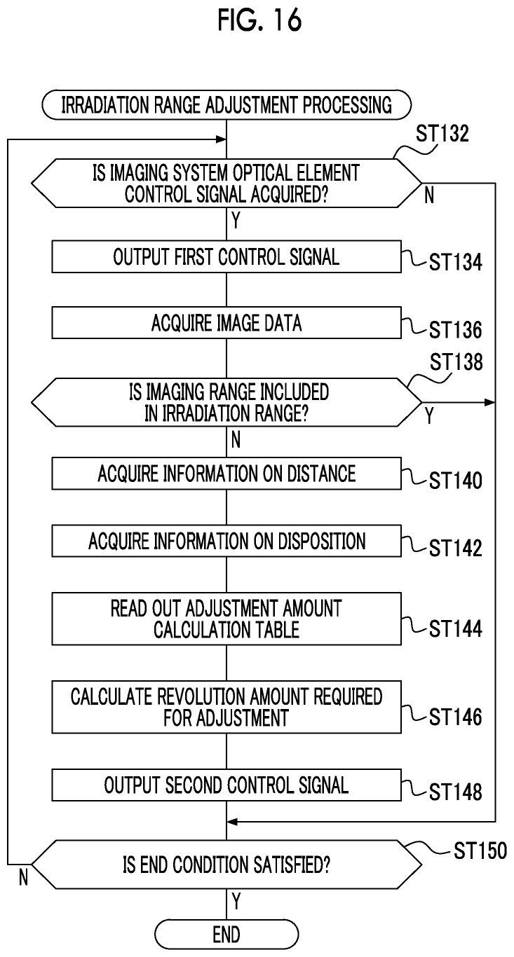

Next, an action of a part according to the technology of the present disclosure in the second embodiment will be described with reference to FIG. 16. FIG. 16 shows an example of a flow of the irradiation range adjustment processing executed by the CPU 61 of the management device 11 in accordance with the irradiation range adjustment processing program 162B. The flow of the irradiation range adjustment processing shown in FIG. 16 is an example of a “control method of the imaging system” according to the technology of the present disclosure.

As an example, in the irradiation range adjustment processing shown in FIG. 16, first, in step ST132, the drive source control unit 61A determines whether or not the imaging system optical element control signal is received from the reception device 64. In a case in which the imaging system optical element control signal is not received from the reception device 64 in step ST132, a negative determination is made, and the irradiation range adjustment processing proceeds to step ST150. In a case in which the drive source control unit 61A receives the imaging system optical element control signal from the reception device 64 in step ST132, a positive determination is made, and the irradiation range adjustment processing proceeds to step ST134.

In step ST134, the drive source control unit 61A outputs the first control signal to the imaging system motor 20 of the imaging apparatus 10 and the projection system motor 120 of the projector 110. The irradiation range adjustment processing proceeds to step ST136.

In step ST136, the irradiation range determination unit 61B acquires the image data from the memory 24C of the imaging apparatus 10. The irradiation range adjustment processing proceeds to step ST138.

In step ST138, the irradiation range determination unit 61B specifies the positional relationship between the imaging range and the irradiation range based on the acquired image data, and determines whether or not the imaging range is included in the irradiation range based on the specified positional relationship between the subject position and the irradiation range. In step ST138, in a case in which the irradiation range determination unit 61B determines that the subject position is included in the irradiation range, a positive determination is made, and the irradiation range adjustment processing proceeds to step ST150. In step ST138, in a case in which the irradiation range determination unit 61B determines that the subject position is not included in the irradiation range, a negative determination is made, and the irradiation range adjustment processing proceeds to step ST140.

In step ST140, the revolution amount calculation unit 61F acquires the information on the distance calculated by the subject distance calculation unit 61E. The irradiation range adjustment processing proceeds to step ST142.

In step ST142, the revolution amount calculation unit 61F acquires the information on the disposition from the storage 62. The irradiation range adjustment processing proceeds to step ST144.

In step ST144, the revolution amount calculation unit 61F reads out the adjustment amount calculation table 62T from the storage 62. The irradiation range adjustment processing proceeds to step ST146.

In step ST146, the revolution amount calculation unit 61F calculates the revolution amount of the revolution mechanism 9 based on the acquired information on the distance, information on the disposition, and adjustment amount calculation table 62T. The irradiation range adjustment processing proceeds to step ST148.

In step ST148, the drive source control unit 61A outputs the second control signal in accordance with the revolution amount of the revolution mechanism 9 calculated by the revolution amount calculation unit 61F to the revolution mechanism 9. The irradiation range adjustment processing proceeds to step ST150.

In step ST150, the drive source control unit 61A determines whether or not a condition for ending the irradiation range adjustment processing (hereinafter, referred to as an “end condition”) is satisfied. Examples of the end condition include a condition that the reception device 64 receives an instruction to end the irradiation range adjustment processing. In a case in which the end condition is not satisfied in step ST150, a negative determination is made, and the irradiation range adjustment processing proceeds to step ST132. In a case in which the end condition is satisfied in step ST150, a positive determination is made, and the irradiation range adjustment processing ends.

As described above, in the imaging system 2, the control signals of the imaging optical system 12 and the projection optical system 112 are shared, and then the irradiation range is adjusted based on the information on the disposition and the information on the distance to the subject S. Therefore, as compared with a case in which the irradiation range is adjusted without being based on the information on the disposition of the imaging apparatus 10 and the projector 110 and the information on the distance to the subject S, it is possible to perform highly accurate imaging in which the irradiation range and the imaging range are matched.

In addition, in the imaging system 2, the information on the distance to the subject S is obtained based on the time required from the emission of the infrared light to the reception of the reflected light by the first image sensor 14, and the irradiation range is adjusted based on the information on the distance. Therefore, as compared with a case in which the distance to the subject S is not measured, the adjustment of the irradiation range is accurate, and it is possible to perform highly accurate imaging in which the irradiation range and the imaging range are matched.

It should be noted that, in the second embodiment, the form example has been described in which the irradiation range is adjusted by the revolution mechanism 9, but the technology of the present disclosure is not limited to this, and the irradiation range may be adjusted by driving the projection system motor 120 of the projector 110. In addition, also in the second embodiment, a configuration may be adopted in which the determination of the adjustment unit is performed in the same manner as in the first embodiment.

In addition, in the second embodiment, the form example has been described in which the information on the distance is calculated based on the time required from the emission of the infrared light to the reception of the reflected light by the first image sensor 14, but the technology of the present disclosure is not limited to this. For example, the information on the distance may be calculated based on the information on the focal length of the imaging apparatus 10. In addition, the information on the distance may be calculated based on information on an image plane phase difference in the image data acquired by the first image sensor 14 and/or the second image sensor 16.

### Third Embodiment

In the first embodiment, the form example has been described in which the irradiation range is adjusted based on the image data acquired by the imaging apparatus 10. However, in a third embodiment, a form example will be described in which the irradiation range is adjusted based on the information on the focal length of the imaging apparatus 10, in addition to the information on the distance to the subject S and the information on the disposition of the projector 110 and the imaging apparatus 10. It should be noted that, in the third embodiment, the components different from the components described in the first and second embodiments will be designated by the same reference numerals, and description thereof will be omitted.

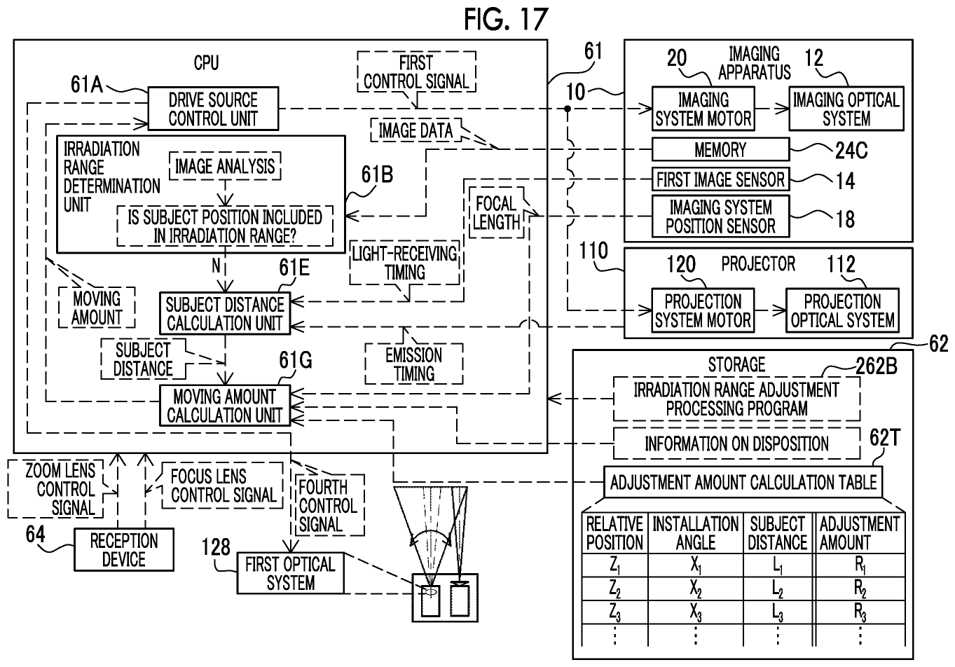

As an example, as shown in FIG. 17, the CPU 61 executes an irradiation range adjustment processing program 262B on the memory 63 to be operated as the drive source control unit 61A, the irradiation range determination unit 61B, the subject distance calculation unit 61E, and a moving amount calculation unit 61G.

The moving amount calculation unit 61G acquires the information on the distance from the subject distance calculation unit 61E. The moving amount calculation unit 61G acquires the information on the focal length from the imaging system position sensor 18 of the imaging apparatus 10. The moving amount calculation unit 61G acquires the adjustment amount calculation table 62T from the storage 62.

The moving amount calculation unit 61G calculates the adjustment amount of the irradiation range based on the acquired information on the distance, information on the disposition, adjustment amount calculation table 62T, and information on the focal length. Specifically, the moving amount calculation unit 61G calculates the zoom lens moving amount to a position at which a pseudo focal length, which is a distance corresponding to the focal length of the projection optical system 112 of the projector 110 is shorter than the focal length of the imaging apparatus 10.

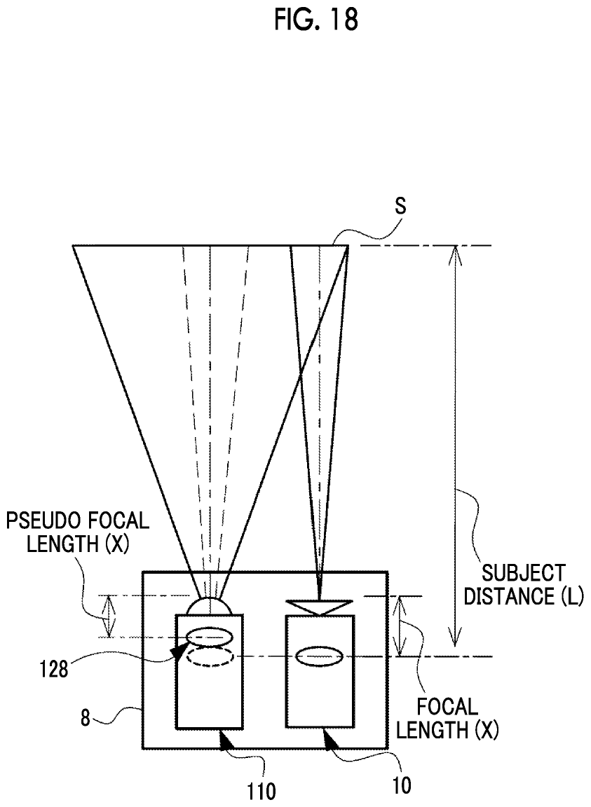

The drive source control unit 61A outputs the second control signal to the projection system motor 120 that drives the projection system zoom lens based on the information on the zoom lens moving amount acquired from the moving amount calculation unit 61G. By changing the position of the projection system zoom lens, as shown in FIG. 18, as an example, the positions of the zoom lens of the projection optical system 112 and the zoom lens of the imaging optical system 12 are adjusted to the position at which the distance corresponding to the focal length of the projector 110 is shorter than the focal length of the imaging apparatus 10. Specifically, the position of each of the first lens group 28A, the second lens group 28B, the third lens group 28C, the fourth lens group 28D, and the fifth lens group 28F as the zoom lens of the imaging optical system 12 is adjusted by the imaging system motor 20, and the position of each of the first lens group 128A, the second lens group 128B, the third lens group 128C, the fourth lens group 128D, and the fifth lens group 128F as the zoom lens of the projection optical system 112 is adjusted by the projection system motor 120. Therefore, the irradiation range is expanded and the imaging range is included in the irradiation range, so that the imaging range and the irradiation range are matched.

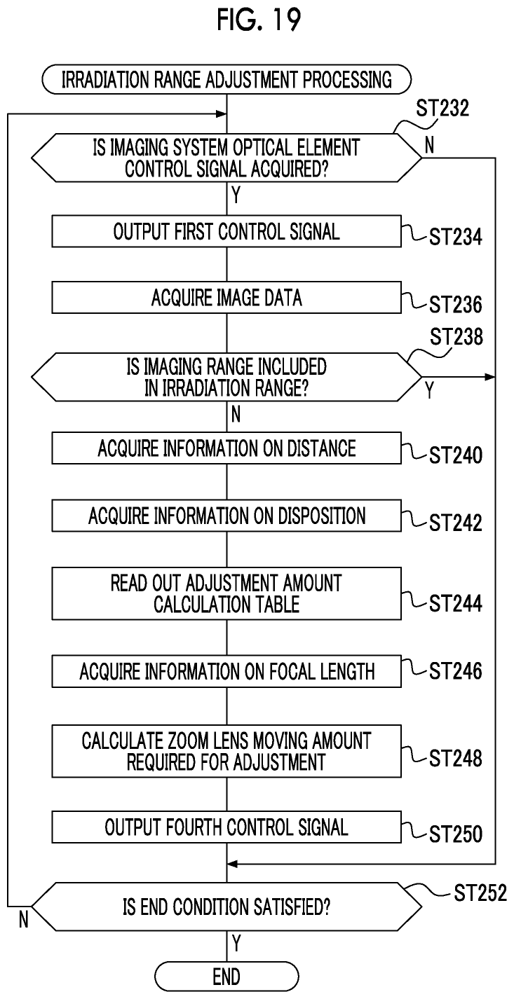

Next, an action of a part according to the technology of the present disclosure in the third embodiment will be described with reference to FIG. 19. FIG. 19 shows an example of a flow of the irradiation range adjustment processing executed by the CPU 61 of the management device 11 in accordance with the irradiation range adjustment processing program 262B. The flow of the irradiation range adjustment processing shown in FIG. 19 is an example of a “control method of the imaging system” according to the technology of the present disclosure.

As an example, in the irradiation range adjustment processing shown in FIG. 19, first, in step ST232, the drive source control unit 61A determines whether or not the imaging system optical element control signal is received from the reception device 64. In a case in which the imaging system optical element control signal is not received from the reception device 64 in step ST232, a negative determination is made, and the irradiation range adjustment processing proceeds to step ST252. In a case in which the drive source control unit 61A receives the imaging system optical element control signal from the reception device 64 in step ST232, a positive determination is made, and the irradiation range adjustment processing proceeds to step ST234.

In step ST234, the drive source control unit 61A outputs the first control signal to the imaging system motor 20 of the imaging apparatus 10 and the projection system motor 120 of the projector 110. The irradiation range adjustment processing proceeds to step ST236.

In step ST236, the irradiation range determination unit 61B acquires the image data from the memory 24C of the imaging apparatus 10. The irradiation range adjustment processing proceeds to step ST238.

In step ST238, the irradiation range determination unit 61B specifies the positional relationship between the imaging range and the irradiation range based on the image data acquired from the memory 24C, and determines whether or not the imaging range is included in the irradiation range based on the specified positional relationship between the subject position and the irradiation range. In step ST238, in a case in which the irradiation range determination unit 61B determines that the subject position is included in the irradiation range, a positive determination is made, and the irradiation range adjustment processing proceeds to step ST252. In step ST238, in a case in which the irradiation range determination unit 61B determines that the subject position is not included in the irradiation range, a negative determination is made, and the irradiation range adjustment processing proceeds to step ST240.

In step ST240, the moving amount calculation unit 61G acquires the information on the distance from the subject distance calculation unit 61E. The irradiation range adjustment processing proceeds to step ST242.

In step ST242, the moving amount calculation unit 61G acquires the information on the disposition from the storage 62. The irradiation range adjustment processing proceeds to step ST244.

In step ST244, the moving amount calculation unit 61G reads out the adjustment amount calculation table 62T from the storage 62. The irradiation range adjustment processing proceeds to step ST246.

In step ST246, the moving amount calculation unit 61G acquires the information on the focal length from the imaging system position sensor 18. The irradiation range adjustment processing proceeds to step ST248.

In step ST248, the moving amount calculation unit 61G calculates the zoom lens moving amount based on the acquired information on the distance, information on the disposition, adjustment amount calculation table 62T, and information on the focal length. The irradiation range adjustment processing proceeds to step ST250.

In step ST250, the drive source control unit 61A outputs the fourth control signal in accordance with the zoom lens moving amount calculated by the moving amount calculation unit 61G to the projection system motor 120 that drives the projection system zoom lens. The irradiation range adjustment processing proceeds to step ST252.

In step ST252, the drive source control unit 61A determines whether or not a condition for ending the irradiation range adjustment processing (hereinafter, referred to as an “end condition”) is satisfied. Examples of the end condition include a condition that the reception device 64 receives an instruction to end the irradiation range adjustment processing. In a case in which the end condition is not satisfied in step ST252, a negative determination is made, and the irradiation range adjustment processing proceeds to step ST232. In a case in which the end condition is satisfied in step ST252, a positive determination is made, and the irradiation range adjustment processing ends.

In the imaging system 2, the irradiation range is adjusted based on the information on the disposition, the information on the distance, and the information on the focal length, so that it is possible to perform highly accurate imaging in which the irradiation range and the imaging range are matched, as compared with a case in which the irradiation range is adjusted without being based on the information on the disposition, the information on the distance, and the information on the focal length.

In the imaging system 2, the position of the projection system zoom lens is adjusted to adjust the irradiation range, so that the adjustment of the irradiation range can be realized in accordance with an angle of view of the imaging apparatus 10. As a result, it is possible to perform highly accurate imaging in which the irradiation range and the imaging range are matched, as compared with a case in which the irradiation range is adjusted without using the projection system zoom lens.

### Fourth Embodiment

In the second embodiment, the form example has been described in which the information on the distance is calculated based on the time required for the reception of the reflected light by using the TOF image sensor as the first image sensor 14. However, in a fourth embodiment, a form example will be described in which the information on the distance is acquired by using a distance-measuring sensor 50. It should be noted that, in the fourth embodiment, the components different from the components described in the first to third embodiments will be designated by the same reference numerals, and description thereof will be omitted.

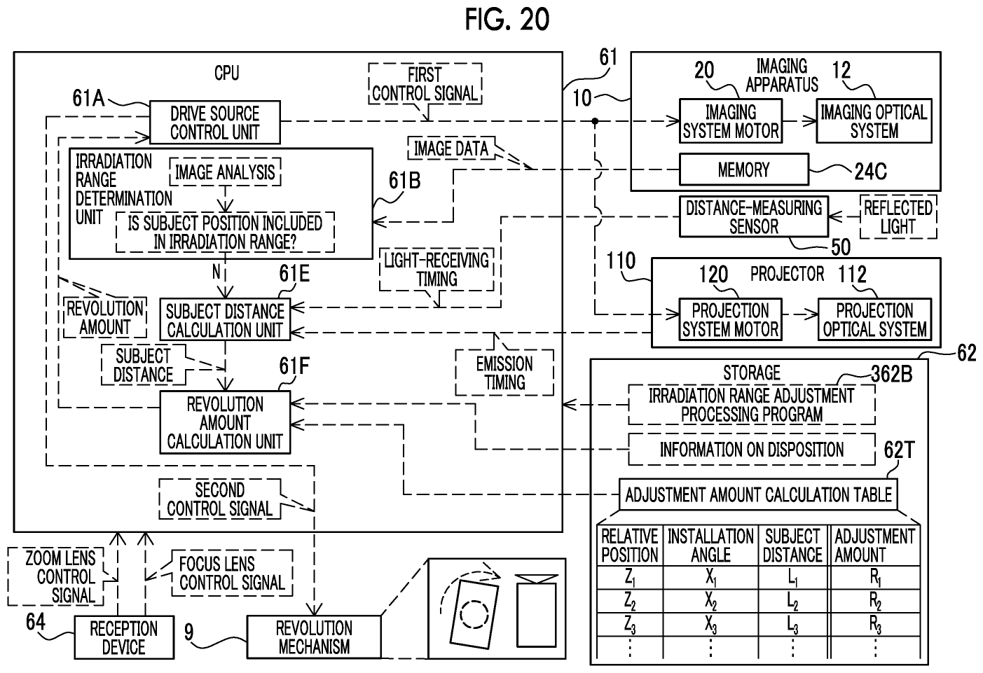

As an example, as shown in FIG. 20, the CPU 61 executes an irradiation range adjustment processing program 362B on the memory 63 to be operated as the drive source control unit 61A, the irradiation range determination unit 61B, the subject distance calculation unit 61E, and the revolution amount calculation unit 61F.

In addition, as shown in FIG. 20 as an example, the imaging system 2 includes the distance-measuring sensor 50. The distance-measuring sensor 50 detects the reflected light emitted from the first light source 114 and reflected by the subject S. In a case in which the reflected light is acquired, the distance-measuring sensor 50 outputs the light-receiving timing signal to the subject distance calculation unit 61E. It should be noted that the distance-measuring sensor 50 is an example of a “distance-measuring sensor” according to the technology of the present disclosure.

The subject distance calculation unit 61E acquires the light-receiving timing signal from the distance-measuring sensor 50. In addition, the subject distance calculation unit 61E acquires the emission timing signal at which the infrared light is emitted from the projector 110. Further, the subject distance calculation unit 61E calculates the information on the distance to the subject S based on the light-receiving timing and the emission timing.

In the imaging system 2, the distance-measuring sensor 50 obtains the information on the distance to the subject S, and the irradiation range is adjusted based on the information on the distance. Therefore, as compared with a case in which the distance to the subject S is not measured, the adjustment of the irradiation range is accurate, and it is possible to perform highly accurate imaging in which the irradiation range and the imaging range are matched.

### Fifth Embodiment

In the second to fourth embodiments described above, the form example has been described in which the information on the distance and the like are acquired each time and the irradiation range is adjusted. However, in a fifth embodiment, a form example will be described in which the information on the distance and the like are stored in advance in a case in which a predetermined condition is satisfied during daytime and is used in a case in which the irradiation range needs to be adjusted in the projector 110 during night. It should be noted that, in the fifth embodiment, the components different from the components described in the first to fourth embodiments will be designated by the same reference numerals, and description thereof will be omitted.

First, imaging in a relatively bright environment, such as during the daytime, is considered as an example. In this case, in imaging by the imaging apparatus 10, since the light amount within the imaging range is sufficiently secured as compared with a relatively dark environment, such as at night, imaging is realized and the subject S is easily identified, so that the distance to the subject S can be measured accurately.

On the other hand, in the relatively dark environment, such as night, in which the projection by the projector 110 of the imaging system 2 and imaging of the imaging apparatus 10 are performed, it is difficult to measure the distance to the subject S before the projection by the projector 110 is performed. Therefore, in order to adjust the irradiation range by the projector 110 and the imaging range by the imaging apparatus 10, it is required to identify the subject S after starting the projection by the projector 110, and further adjust the irradiation range and the imaging range. Therefore, it is assumed that it takes time to start imaging in a state in which the projection is performed onto the subject S within an appropriate range.

Therefore, in the fifth embodiment, the information on the distance is acquired and stored in an imaging environment satisfying the predetermined condition, such as daytime, and the information on the distance that is stored in advance is used in the imaging environment, such as night, so that the adjustment of the irradiation range is realized.

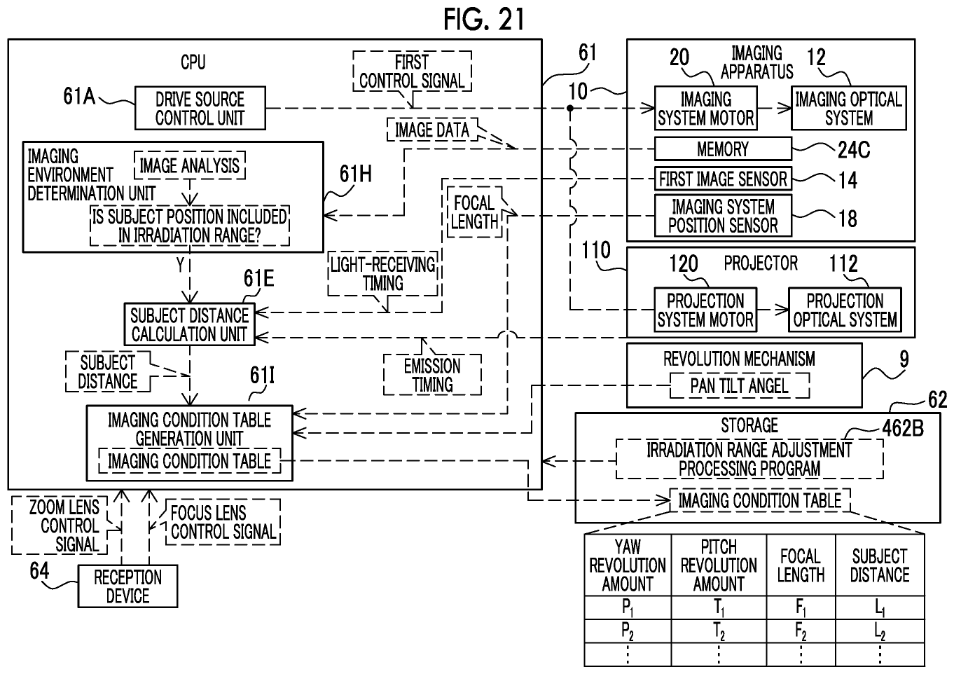

First, a case is considered in which imaging is performed in the relatively bright environment, such as daytime. The CPU 61 reads out an irradiation range adjustment processing program 462B from the storage 62 and executes the read out irradiation range adjustment processing program 462B on the memory 63 (see FIG. 6). As an example, as shown in FIG. 21, the CPU 61 executes the irradiation range adjustment processing program 462B on the memory 63 to be operated as the drive source control unit 61A, an imaging environment determination unit 61H, the subject distance calculation unit 61E, an imaging condition table generation unit 61I, a table usage condition determination unit 61J, an acquisition unit 61K, an imaging condition table determination unit 61L, the irradiation range determination unit 61B, the adjustment unit determination unit 61C, and the adjustment amount calculation unit 61D.

As an example, as shown in FIG. 21, the imaging environment determination unit 61H performs image analysis on the image data acquired from the memory 24C and determines whether or not brightness of the image data is equal to or more than a predetermined value. That is, it is determined whether or not the imaging environment is the relatively bright environment, such as daytime.

In a case in which a positive determination is made in the imaging environment determination unit 61H, the subject distance calculation unit 61E calculates the distance to the subject S based on the infrared light emission timing and the light-receiving timing. The calculated information on the distance is output to the imaging condition table generation unit 61I.

The imaging condition table generation unit 61I generates a table (hereinafter, simply referred to as an “imaging condition table”) related to an imaging condition in the imaging environment (as an example, daytime) that satisfies the predetermined condition. Specifically, the imaging condition table generation unit 61I generates the imaging condition table based on the information on the distance and the information on a revolution state acquired from the revolution mechanism 9. As an example of the information on the revolution state, the revolution amount in the yaw direction and the revolution amount in the pitch direction of the revolution mechanism 9 (hereinafter, may be simply referred to as “pan tilt angle”). In addition, the imaging condition table generation unit 61I may acquire the information on the focal length of the imaging apparatus 10 and generate the imaging condition table in addition to the information on the revolution state. Specifically, the information on the focal length is acquired based on the position of the focus lens detected by the imaging system position sensor 18 of the imaging apparatus 10. The imaging condition table generation unit 61I stores the generated imaging condition table in the storage 62. It should be noted that the storage 62 is an example of a “memory” according to the technology of the present disclosure.

It should be noted that the imaging condition table generation unit 61I may generate the imaging condition table by interpolating the imaging condition based on the acquired imaging condition as well as the imaging condition in which imaging is actually performed. In addition, the imaging condition table generation unit 61I may be generated by classifying the acquired imaging condition as well as the imaging condition in which the imaging is actually performed. For example, the imaging condition may be classified into a distant view, a middle view, or a near view in accordance with the distance to the subject, and the imaging condition table for each of these classifications may be generated.

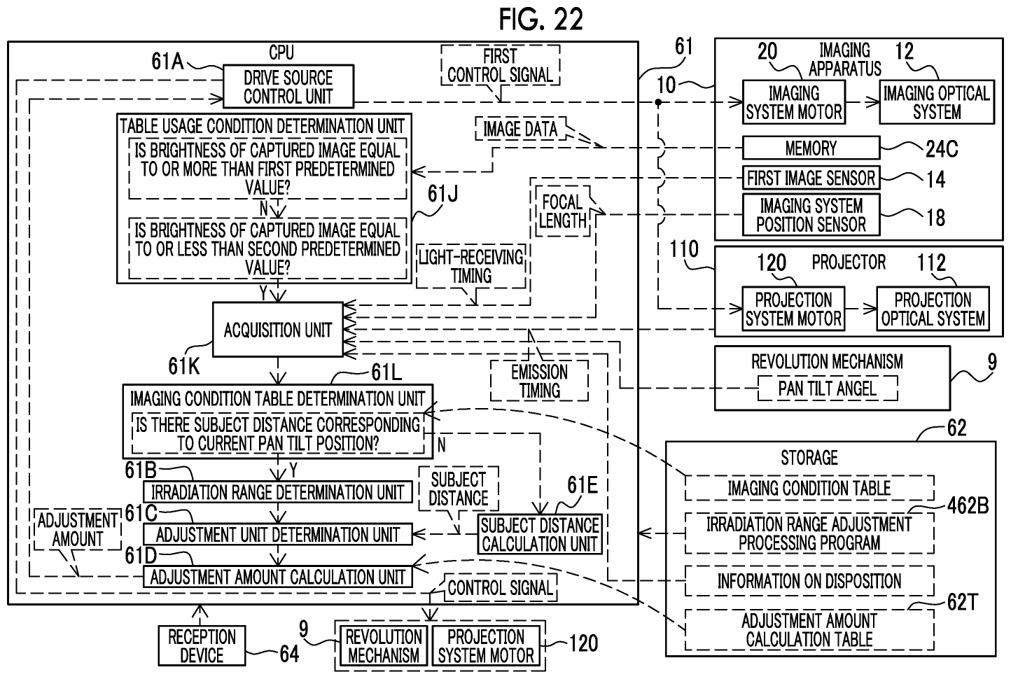

Next, a case is considered in which the projection by the projector 110 and imaging by the imaging apparatus 10 are performed in the relatively dark environment, such as at night. As an example, as shown in FIG. 22, the table usage condition determination unit 61J acquires the image data from the memory 24C. Further, the table usage condition determination unit 61J performs the image analysis on the acquired image data and determines whether or not the brightness in the image data is equal to or more than a first predetermined value. In a case in which a negative determination is made, that is, in a case in which it is determined that the imaging environment is not enough to store the imaging condition, the table usage condition determination unit 61J further determines whether or not the brightness of the image data is equal to or less than a second predetermined value. In a case in which a positive determination is made, that is, in a case in which it is determined that the imaging environment (for example, night) in which the imaging condition table should be used, the table usage condition determination unit 61J outputs the determination result to the acquisition unit 61K.

The acquisition unit 61K acquires the light-receiving timing and the emission timing of the infrared light from the first image sensor 14. The acquisition unit 61K acquires the information on the disposition from the storage 62. The acquisition unit 61K acquires the current pan tilt angle from the revolution mechanism 9. The acquisition unit 61K acquires the information on the focal length from the imaging system position sensor 18.

The imaging condition table determination unit 61L reads out the imaging condition table, and determines whether or not there is the information on the distance to the subject S corresponding to the current imaging condition in the imaging condition table based on the current pan tilt angle and focal length of the revolution mechanism 9 acquired from the acquisition unit 61K. In a case in which it is determined that there is the information on the distance corresponding to the current imaging condition in the imaging condition table, the imaging condition table determination unit 61L outputs the information on the distance to the adjustment unit determination unit 61C.

On the other hand, in the determination by the imaging condition table determination unit 61L, in a case in which it is not determined that there is the information on the distance corresponding to the current imaging condition in the imaging condition table, the subject distance calculation unit 61E calculates the distance to the subject S based on the emission timing and the light-receiving timing. Further, the subject distance calculation unit 61E outputs the information on the distance to the adjustment unit determination unit 61C.

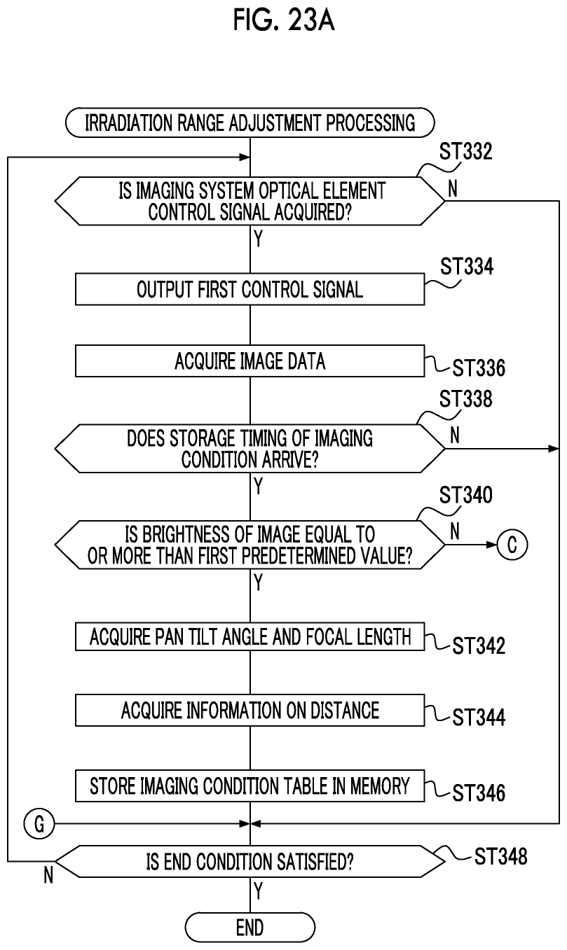

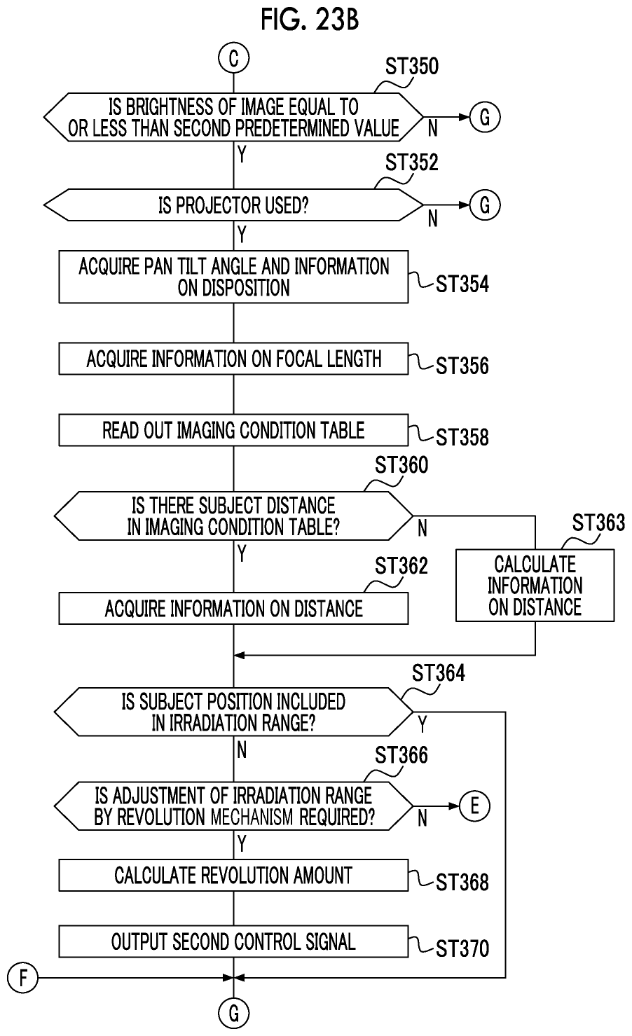

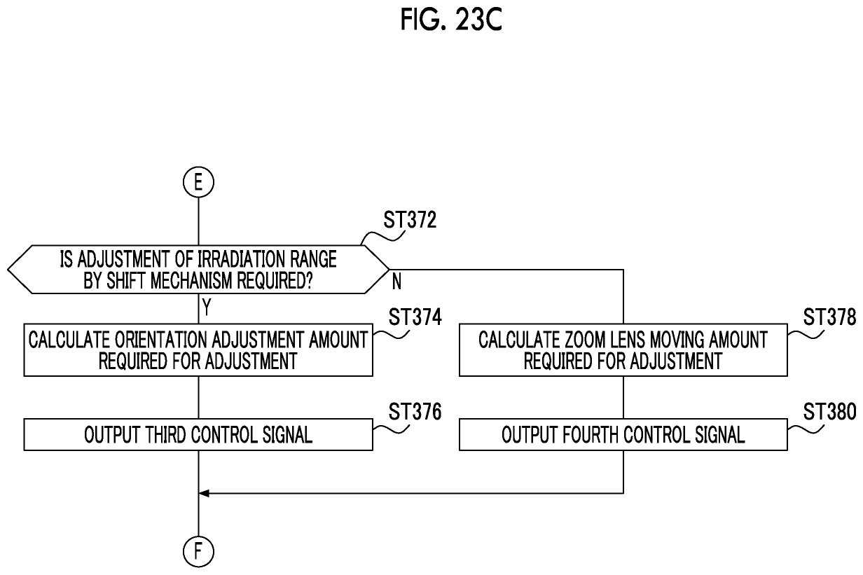

Next, an action of a part according to the technology of the present disclosure in the fifth embodiment will be described with reference to FIGS. 23A and 23B. FIG. 23A shows an example of a flow of the irradiation range adjustment processing executed by the CPU 61 of the management device 11 in accordance with the irradiation range adjustment processing program 462B. The flow of the irradiation range adjustment processing shown in FIGS. 23A and 23B is an example of a “control method of the imaging system” according to the technology of the present disclosure.

As an example, in the irradiation range adjustment processing shown in FIG. 23A, first, in step ST332, the drive source control unit 61A determines whether or not the imaging system optical element control signal is received from the reception device 64. In a case in which the imaging system optical element control signal is not received from the reception device 64 in step ST332, a negative determination is made, and the irradiation range adjustment processing proceeds to step ST348. In a case in which the drive source control unit 61A receives the imaging system optical element control signal from the reception device 64 in step ST332, a positive determination is made, and the irradiation range adjustment processing proceeds to step ST334.

In step ST334, the drive source control unit 61A outputs the first control signal to the imaging system motor 20 of the imaging apparatus 10 and the projection system motor 120 of the projector 110. The irradiation range adjustment processing proceeds to step ST336.

In step ST336, the imaging environment determination unit 61H acquires the image data from the memory 24C of the imaging apparatus 10. The irradiation range adjustment processing proceeds to step ST338.

In step ST338, the imaging environment determination unit 61H determines whether or not a storage timing of the imaging condition arrives. In step ST338, in a case in which the imaging environment determination unit 61H does not determine that the storage timing arrives, a negative determination is made, and the irradiation range adjustment processing proceeds to step ST348. In step ST338, in a case in which the imaging environment determination unit 61H determines that the storage timing of the imaging condition arrives, a positive determination is made, and the irradiation range adjustment processing proceeds to step ST340.

In step ST340, the imaging environment determination unit 61H determines whether or not the brightness of the image data is equal to or more than the first predetermined value. In a case in which the imaging environment determination unit 61H determines that the brightness of the image data is equal to or more than the first predetermined value, a positive determination is made, and the irradiation range adjustment processing proceeds to step ST342. In step ST340, in a case in which the imaging environment determination unit 61H does not determine that the brightness of the image data is equal to or more than the first predetermined value, a negative determination is made, and the irradiation range adjustment processing proceeds to step ST350 as shown in FIG. 23B as an example.

In step ST342, the imaging condition table generation unit 61I acquires the current pan tilt angle and the information on the focal length. The irradiation range adjustment processing proceeds to step ST344.

In step ST344, the imaging condition table generation unit 61I acquires the information on the distance from the acquisition unit 61K. The irradiation range adjustment processing proceeds to step ST346.

In step ST346, the imaging condition table generation unit 61I stores the imaging condition table generated based on the pan tilt angle, the information on the focal length, and the information on the distance in the memory. The irradiation range adjustment processing proceeds to step ST348.

In step ST350, the table usage condition determination unit 61J determines whether or not the brightness of the image data is equal to or less than the second predetermined value. In a case in which the table usage condition determination unit 61J does not determine that the brightness of the image data is equal to or less than the second predetermined value, a negative determination is made, and the irradiation range adjustment processing proceeds to step ST348 as shown in FIG. 23A as an example. In step ST350, in a case in which the table usage condition determination unit 61J determines that the brightness of the image data is equal to or less than the second predetermined value, a positive determination is made, and the irradiation range adjustment processing proceeds to step ST352.

In step ST352, the table usage condition determination unit 61J determines whether or not to perform the projection by using the projector 110. In a case in which the table usage condition determination unit 61J does not determine to perform the projection by using the projector 110, a negative determination is made, and the irradiation range adjustment processing proceeds to step ST348 as shown in FIG. 23A as an example. In step ST352, in a case in which the table usage condition determination unit 61J determines to perform the projection by using the projector 110, a positive determination is made, and the irradiation range adjustment processing proceeds to step ST354.

In step ST354, the acquisition unit 61K acquires the pan tilt angle from the revolution mechanism 9. In addition, the acquisition unit 61K acquires the information on the disposition from the storage 62. The irradiation range adjustment processing proceeds to step ST356.

In step ST356, the acquisition unit 61K acquires the information on the focal length from the imaging system position sensor 18. The irradiation range adjustment processing proceeds to step ST358.

In step ST358, the imaging condition table determination unit 61L reads out the imaging condition table from the storage 62. The imaging irradiation range adjustment processing proceeds to step ST360.

In step ST360, the imaging condition table determination unit 61L determines whether or not the imaging condition table includes the acquired pan tilt angle, the information on the disposition, and the information on the distance corresponding to the information on the focal length. In a case in which the imaging condition table determination unit 61L determines that there is the information on the distance, a positive determination is made, and the irradiation range adjustment processing proceeds to step ST362. In step ST360, in a case in which the imaging condition table determination unit 61L does not determine that there is the information on the distance in the imaging condition table, a negative determination is made, and the irradiation range adjustment processing proceeds to step ST363.

In step ST362, the imaging condition table determination unit 61L acquires the information on the distance. The irradiation range adjustment processing proceeds to step ST364.

In step ST363, the subject distance calculation unit 61E calculates the information on the distance. The irradiation range adjustment processing proceeds to step ST364.

In step ST364, the irradiation range determination unit 61B determines whether or not the subject position is included in the irradiation range. In a case in which the irradiation range determination unit 61B does not determine that the irradiation range includes the subject position, the irradiation range adjustment processing proceeds to step ST366. In step ST364, in a case in which the irradiation range determination unit 61B determines that the subject position is included in the irradiation range, the irradiation range adjustment processing proceeds to step ST348 as shown in FIG. 23A as an example.

In step ST366, the adjustment unit determination unit 61C determines whether or not the irradiation range needs to be adjusted by the revolution mechanism 9. In a case in which the adjustment unit determination unit 61C determines that the adjustment by the revolution mechanism 9 is required, a positive determination is made, and the irradiation range adjustment processing proceeds to step ST368. In step ST366, in a case in which the adjustment unit determination unit 61C does not determine that adjustment by the revolution mechanism 9 is required, a negative determination is made, and the irradiation range adjustment processing proceeds to step ST372 as shown in FIG. 23C as an example.

In step ST368, the adjustment amount calculation unit 61D calculates the revolution amount required to adjust the irradiation range. The irradiation range adjustment processing proceeds to step ST370.

In step ST370, the drive source control unit 61A outputs the second control signal corresponding to the revolution amount calculated by the adjustment amount calculation unit 61D to the revolution mechanism 9. The irradiation range adjustment processing proceeds to step ST348.

As an example, as shown in FIG. 23C, in step ST372, the adjustment unit determination unit 61C determines whether or not the irradiation range needs to be adjusted by the lens shift mechanism 112B2. In a case in which the adjustment unit determination unit 61C determines that the irradiation range needs to be adjusted by the lens shift mechanism 112B2, a positive determination is made, and the irradiation range adjustment processing proceeds to step ST374. In step ST372, in a case in which the adjustment unit determination unit 61C does not determine that adjustment by the lens shift mechanism 112B2 is required, a negative determination is made, and the irradiation range adjustment processing proceeds to step ST378.

In step ST374, the adjustment amount calculation unit 61D calculates the orientation adjustment required for the adjustment by the lens shift mechanism 112B2. The irradiation range adjustment processing proceeds to step ST376.

In step ST376, the drive source control unit 61A outputs the third control signal in accordance with the orientation adjustment amount acquired from the adjustment amount calculation unit 61D to the lens shift mechanism 112B2 of the projector 110. The irradiation range adjustment processing proceeds to step ST248 as shown in FIG. 23A as an example.

In step ST378, the adjustment amount calculation unit 61D calculates the zoom lens moving amount required to adjust the irradiation range. The irradiation range adjustment processing proceeds to step ST380.

In step ST380, the drive source control unit 61A outputs the fourth control signal in accordance with the zoom lens moving amount acquired from the adjustment amount calculation unit 61D to the projection system motor 120 of the projector 110. The irradiation range adjustment processing proceeds to step ST348 as shown in FIG. 23A as an example.

In step ST348, the drive source control unit 61A determines whether or not a condition for ending the irradiation range adjustment processing (hereinafter, referred to as an “end condition”) is satisfied. Examples of the end condition include a condition that the reception device 64 receives an instruction to end the irradiation range adjustment processing. In a case in which the end condition is not satisfied in step ST348, a negative determination is made, and the irradiation range adjustment processing proceeds to step ST332. In a case in which the end condition is satisfied in step ST348, a positive determination is made, and the irradiation range adjustment processing ends.

In the imaging system 2, by storing the information on the distance in accordance with the imaging condition in the imaging environment that satisfies the predetermined condition, the stored information on the distance can be used in a case of the same imaging condition, and it is easy to perform calculation processing required for the position adjustment of the irradiation range as compared with a case in which the information on the distance is acquired each time.

In the imaging system 2, by storing the information on the focal length as the imaging condition, the information on the focal length can be used in a case of determining whether or not it is the same imaging condition, and the calculation processing required for the position adjustment of the irradiation range is accurate as compared with a case in which the imaging condition is not included as the information on the focal length.

In the imaging system 2, by setting the brightness of the image data indicating the brightness of the imaging environment to be equal to or more than the threshold value as the predetermined condition, it is possible to accurately acquire the information on the distance to the subject S and the like as compared with imaging in a case in which the imaging range including the subject S is dark.

In the imaging system 2, by storing the information on the distance in accordance with the imaging condition in a case in which the predetermined condition is satisfied, the stored information on the distance can be used in a case of the same imaging condition, and it is easy to perform calculation processing required for the position adjustment of the irradiation range as compared with a case in which the information on the distance to the subject S is acquired each time.

In the imaging system 2, in a case in which a first predetermined condition related to whether or not the environment is the relatively bright environment, such as daytime, is not satisfied, the information on the distance that is stored in advance is used, so that it is possible to adjust the irradiation range in accordance with the current imaging condition as compared with a case in which the information on the distance that is always stored.

In the imaging system 2, only in a case in which the first predetermined condition related to whether or not the environment is the relatively bright environment, such as daytime, is not satisfied and a second predetermined condition related to whether or not the environment is the relatively dark environment, such as night, is satisfied, the information on the distance that is stored in advance is used, so that it is possible to adjust the irradiation range in accordance with the current imaging condition as compared with a case in which the information on the distance that is always stored.

In the imaging system 2, by setting the brightness to be equal to or less than the threshold value as the second predetermined condition, even in a case in which the imaging environment around the subject S is bright to the extent that imaging can be performed, it is possible to accurately determine a case in which the information on the distance is required, as compared with a case in which the stored information on the distance is used.

It should be noted that, in the fifth embodiment, the form example has been described in which the brightness of the image data is used as an index indicating the brightness of the imaging environment as the first or second predetermined condition, but the technology of the present disclosure is not limited to this. For example, information on the brightness acquired by a photometer may be used as the index indicating the brightness of the imaging environment. Further, in the fifth embodiment, the index indicating the brightness has been described as the first or second predetermined condition, but the technology of the present disclosure is not limited to this, and the brightness of the imaging environment need only be estimated by the first or second predetermined condition, information on a time slot, weather, or season may be used as the first or second predetermined condition, and these pieces of information may be used together with the information on the brightness.

In each of the embodiments described above, the form example has been described in which the drive source control unit 61A that receives the signal from the reception device 64 outputs the first control signal to the imaging apparatus 10 and the projector 110, but the technology of the present disclosure is not limited to this. For example, in the adjustment of the optical systems of the imaging apparatus 10 and the projector 110, the imaging optical system 12 of the imaging apparatus 10 may be manually adjusted, and the projection optical system 112 of the projector 110 may be adjusted accordingly. In addition, the signal in accordance with the adjustment amount obtained based on the result of image analysis of the captured image obtained by the imaging apparatus 10 may be shared as the first control signal of the optical systems of the imaging apparatus 10 and the projector 110.

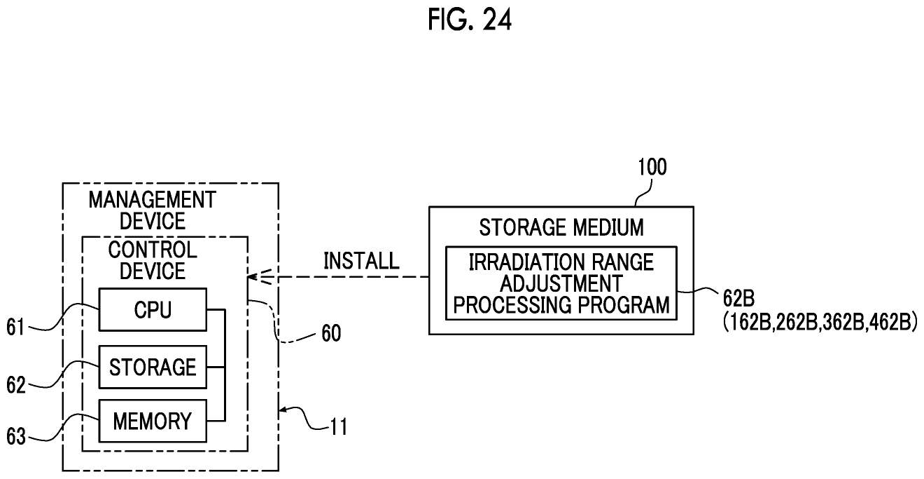

In each of the embodiments described above, the storage 62 of the management device 11 stores the irradiation range adjustment processing program 62B, 162B, 262B, 362B, or 462B (hereinafter, in a case in which distinction is not required, the irradiation range adjustment processing program 62B, 162B, 262B, 362B, or 462B is referred to as the “irradiation range adjustment processing program” without designating the reference numeral). Moreover, the form example has been described in which the irradiation range adjustment processing program is executed by the CPU 61 in the memory 63 of the management device 11. However, the technology of the present disclosure is not limited to this. For example, the irradiation range adjustment processing program may be stored in the storage 24B of the imaging apparatus 10, and the CPU 24A of the imaging apparatus 10 may execute the program in the memory 24C. Further, as shown in FIG. 24 as an example, the irradiation range adjustment processing program may be stored in the storage medium 100. The storage medium 100 is a non-transitory storage medium. Examples of the storage medium 100 include any portable storage medium, such as an SSD or a USB memory. In a case of the example shown in FIG. 24, the irradiation range adjustment processing program stored in the storage medium 100 is installed in the computer 60. Moreover, the CPU 61 executes the irradiation range adjustment processing in accordance with the irradiation range adjustment processing program.

In addition, the irradiation range adjustment processing program may be stored in a storage unit, such as other computers or server devices connected to the computer 60 through a communication network (not shown), and the irradiation range adjustment processing program may be downloaded in response to a request of the management device 11 and installed in the computer 60. In this case, the installed irradiation range adjustment processing program is executed by the CPU 61 of the computer 60.

It should be noted that, all the irradiation range adjustment processing programs do not have to be stored in a storage unit, such as other computers or server devices connected to the computer 60, or the storage 62, and a part of the irradiation range adjustment processing programs may be stored.

In addition, in each of the embodiments described above and the modification example, the CPU 61 is a single CPU, but the technology of the present disclosure is not limited to this, and a plurality of CPUs may be adopted.

In the example shown in FIG. 24, although the computer 60 has been described as an example, the technology of the present disclosure is not limited to this, and a device including an ASIC, an FPGA, and/or a PLD may be applied instead of the computer 60. In addition, instead of the computer 60, the hardware configuration and the software configuration may be used in combination.

Various processors shown below can be used as a hardware resource for executing the irradiation range adjustment processing in each of the embodiments described above. Examples of the processor include a CPU which is a general-purpose processor functioning as the hardware resource for executing the irradiation range adjustment processing by executing software, that is, a program. In addition, examples of the processor include a dedicated electric circuit which is a processor having a circuit configuration designed to be dedicated to execute specific processing, such as an FPGA, a PLD, or an ASIC. A memory is built in or connected to any processor, and any processor executes the irradiation range adjustment processing by using the memory.

The hardware resource for executing the irradiation range adjustment processing may be configured by one of the various processors or may be configured by a combination of two or more processors that are the same type or different types (for example, combination of a plurality of FPGAs or combination of a CPU and an FPGA). In addition, the hardware resource for executing the irradiation range adjustment processing may be one processor.

As an example in which the hardware resource is configured by one processor, first, there is a form in which one processor is configured by a combination of one or more CPUs and software, and the processor functions as the hardware resource for executing the irradiation range adjustment processing. Secondly, as represented by SoC, there is a form in which a processor that realizes the functions of the entire system including a plurality of hardware resources for executing the irradiation range adjustment processing with one IC chip is used. As described above, the irradiation range adjustment processing is realized by using one or more of various processors as the hardware resource.

Further, as the hardware structure of these various processors, more specifically, it is possible to use an electric circuit in which circuit elements, such as semiconductor elements, are combined.

In addition, the irradiation range adjustment processing described above is merely an example. Therefore, it is needless to say that the deletion of an unneeded step, the addition of a new step, and the change of a processing order may be employed within a range not departing from the gist.

The description contents and the shown contents above are the detailed description of the parts according to the technology of the present disclosure, and are merely examples of the technology of the present disclosure. For example, the description of the configuration, the function, the action, and the effect above are the description of examples of the configuration, the function, the action, and the effect of the parts according to the technology of the present disclosure. Accordingly, it is needless to say that unneeded parts may be deleted, new elements may be added, or replacements may be made with respect to the description contents and the shown contents above within a range that does not deviate from the gist of the technology of the present disclosure. In addition, in order to avoid complications and facilitate understanding of the parts according to the technology of the present disclosure, in the description contents and the shown contents above, the description of common technical knowledge and the like that do not particularly require description for enabling the implementation of the technology of the present disclosure are omitted.

In the present specification, “A and/or B” is synonymous with “at least one of A or B”. That is, “A and/or B” means that it may be only A, only B, or a combination of A and B. In addition, in the present specification, in a case in which three or more matters are associated and expressed by “and/or”, the same concept as “A and/or B” is applied.

All documents, patent applications, and technical standards described in the present specification are incorporated into the present specification by reference to the same extent as in a case in which the individual documents, patent applications, and technical standards are specifically and individually stated to be incorporated by reference.

What is claimed is:

1. An imaging system comprising:
an imaging apparatus including a first optical system that transmits first wavelength range light, and a first image sensor that receives the first wavelength range light guided by the first optical system; a projector including a first light source that emits the first wavelength range light, and a second optical system that emits the first wavelength range light emitted from the first light source to a subject side; and
a processor that controls the imaging apparatus and the projector,
wherein an optical specification of the first optical system and an optical specification of the second optical system correspond to each other,
the first optical system includes a first optical element that is displaced by receiving power generated by a first drive source,
the second optical system includes a second optical element that is displaced by receiving power generated by a second drive source, and
the first drive source and the second drive source are capable of being controlled by a common control signal output by the processor.

2. The imaging system according to claim 1, wherein the processor
controls the first drive source by outputting the control signal to the first drive source, and
controls the second drive source by outputting the control signal to the second drive source as a signal for controlling the second drive source.

3. The imaging system according to claim 2,
wherein the first optical element includes a first lens,
the imaging system further comprises a first adjustment mechanism capable of adjusting a position of the first lens by receiving the power generated by the first drive source,
the second optical element includes a second lens,
the imaging system further comprises a second adjustment mechanism capable of adjusting a position of the second lens by receiving the power generated by the second drive source, and
the second adjustment mechanism matches the position of the second lens to a position corresponding to the first lens of which a position is adjusted by the first adjustment mechanism, based on the control signal.

4. The imaging system according to claim 3,
wherein the first lens is a first zoom lens,
the second lens is a second zoom lens, and
the second adjustment mechanism matches a position of the second zoom lens to a position corresponding to the first zoom lens of which a position is adjusted by the first adjustment mechanism, based on the control signal.

5. The imaging system according to claim 3,
wherein the first lens is a first focus lens,
the second lens is a second focus lens, and
the second adjustment mechanism matches a position of the second focus lens to a position corresponding to the first focus lens of which a position is adjusted by the first adjustment mechanism, based on the control signal.

6. The imaging system according to claim 1,
wherein the processor adjusts an irradiation range of the projector.

7. The imaging system according to claim 6,
wherein the processor adjusts the irradiation range of the projector based on image data obtained by imaging a subject by the imaging apparatus.

8. The imaging system according to claim 6,
wherein the processor adjusts the irradiation range of the projector based on information on disposition of the imaging apparatus and the projector, and information on a distance to a subject.

9. The imaging system according to claim 8,
wherein the imaging apparatus further includes a distance-measuring sensor that measures the distance.

10. The imaging system according to claim 8,
wherein the processor acquires the information on the distance to the subject based on an emission timing at which the first wavelength range light is emitted from the first light source, and a light-receiving timing at which first subject light obtained by reflecting the first wavelength range light emitted from the first light source by the subject is received by the first image sensor.

11. The imaging system according to claim 1,
wherein the second optical system further includes a third lens as the second optical element, and a drive mechanism capable of moving the third lens in a direction intersecting an optical axis of the second optical system, and
the processor adjusts an irradiation range of the projector by controlling the drive mechanism to move the third lens.

12. The imaging system according to claim 1,
wherein the processor adjusts an irradiation range of the projector by operating a first revolution mechanism capable of revolving the projector.

13. The imaging system according to claim 1,
wherein the second optical element includes a third zoom lens, and
the processor adjusts an irradiation range of the projector by moving the third zoom lens along an optical axis of the second optical system.

14. The imaging system according to claim 1,
wherein the processor adjusts an irradiation range of the projector based on information on disposition of the imaging apparatus and the projector, information on a distance to a subject, and information on a focal length.

15. The imaging system according to claim 1,
wherein the first optical element includes a fourth zoom lens,
the second optical element includes a fifth zoom lens, and
the processor adjusts positions of the fourth zoom lens and the fifth zoom lens to a position at which a focal length of the second optical system is shorter than a focal length of the first optical system, based on information on disposition of the imaging apparatus and the projector, information on a distance to a subject, and information on a focal length.

16. An imaging system comprising:
an imaging apparatus including a first optical system that transmits first wavelength range light, and a first image sensor that receives the first wavelength range light guided by the first optical system;
a projector including a first light source that emits the first wavelength range light, and a second optical system that emits the first wavelength range light emitted from the first light source to a subject side; and
a processor that controls the imaging apparatus and the projector,
wherein an optical specification of the first optical system and an optical specification of the second optical system correspond to each other,
the first optical system includes a first optical element that is displaced by receiving power generated by a first drive source,
the second optical system includes a second optical element that is displaced by receiving power generated by a second drive source,
the processor controls the first drive source and the second drive source, and
in a case in which an environment in which a subject is imaged satisfies a first predetermined condition, the processor stores information on a distance to the subject in accordance with an imaging condition of the imaging apparatus in a memory.

17. The imaging system according to claim 16,
wherein the imaging condition includes information on a focal length of the imaging apparatus.

18. The imaging system according to claim 16,
wherein the first predetermined condition includes a condition that an index indicating brightness in an imaging range including the subject is equal to or more than a first threshold value.

19. The imaging system according to claim 16,
wherein the processor
acquires the information on the distance to the subject in accordance with the imaging condition of the imaging apparatus stored in the memory, and
adjusts an irradiation range of the projector based on the acquired information on the distance to the subject.

20. The imaging system according to claim 16,
wherein the processor
in a case in which the environment in which the subject is imaged does not satisfy the first predetermined condition, acquires the information on the distance to the subject in accordance with the imaging condition of the imaging apparatus stored in the memory, and
adjusts an irradiation range based on the acquired information on the distance to the subject.

21. The imaging system according to claim 20,
wherein the processor
in a case in which the environment in which the subject is imaged does not satisfy the first predetermined condition and the environment in which the subject is imaged satisfies a second predetermined condition, acquires the information on the distance to the subject in accordance with the imaging condition of the imaging apparatus stored in the memory, and
adjusts an irradiation range of the projector based on the acquired information on the distance to the subject.

22. The imaging system according to claim 21,
wherein the second predetermined condition includes a condition that an index indicating brightness in an imaging range including the subject is equal to or less than a second threshold value.

23. The imaging system according to claim 1,
wherein the first wavelength range light is long-wavelength light having a longer wavelength than visible light.

24. The imaging system according to claim 1,
wherein the first optical system transmits the first wavelength range light and second wavelength range light,
the first optical system further includes a separation optical system that separates light including the first wavelength range light and the second wavelength range light into the first wavelength range light and the second wavelength range light,
the imaging apparatus further includes a second image sensor that receives the second wavelength range light separated by the separation optical system,
the projector further includes a second light source that emits the second wavelength range light,
the second optical system is capable of emitting the first wavelength range light and the second wavelength range light to the subject side, and
the second optical system further includes a synthetic optical system that synthesizes the second wavelength range light emitted from the second light source with the first wavelength range light emitted from the first light source.

25. The imaging system according to claim 24,
wherein the second wavelength range light is visible light, and
the first wavelength range light is long-wavelength light having a longer wavelength than the visible light.

26. The imaging system according to claim 25,
wherein the long-wavelength light is light in an infrared light wavelength range having a wavelength range of 1400 nm or more and 2600 nm or less.

27. The imaging system according to claim 26,
wherein the infrared light wavelength range is a near-infrared light wavelength range including 1550 nm.

28. The imaging system according to claim 25,
wherein the long-wavelength light is light in a near-infrared light wavelength range having a wavelength range of 750 nm or more and 1000 nm or less.

29. The imaging system according to claim 1 further comprising:
a second revolution mechanism capable of revolving the projector.

30. A control method of an imaging system including an imaging apparatus including a first optical system that transmits first wavelength range light, and a first image sensor that receives the first wavelength range light guided by the first optical system, and a projector including a first light source that emits the first wavelength range light, and a second optical system that emits the first wavelength range light emitted from the first light source to a subject side, in which an optical specification of the first optical system and an optical specification of the second optical system correspond to each other, the first optical system includes a first optical element that is displaced by receiving power generated by a first drive source, the second optical system includes a second optical element that is displaced by receiving power generated by a second drive source, and the imaging system further includes a processor that controls the imaging apparatus and the projector, the method comprising:
controlling the first drive source and the second drive source by the processor via a common control signal.

31. A non-transitory computer-readable storage medium storing program causing a computer applied to an imaging system including an imaging apparatus including a first optical system that transmits first wavelength range light, and a first image sensor that receives the first wavelength range light guided by the first optical system, and a projector including a first light source that emits the first wavelength range light, and a second optical system that emits the first wavelength range light emitted from the first light source to a subject side, in which an optical specification of the first optical system and an optical specification of the second optical system correspond to each other, the first optical system includes a first optical element that is displaced by receiving power generated by a first drive source, the second optical system includes a second optical element that is displaced by receiving power generated by a second drive source, and the imaging system further includes a processor that controls the imaging apparatus and the projector, to execute a process comprising:
controlling the first drive source and the second drive source via a common control signal.
